(19) United States
(12) Patent Application Publication
(10) Pub. No.: US 2026/0193540 A1
(43) Pub. Date: Jul. 9, 2026

(54) INTEGRATED DEVICES FOR DRYING ORGANIC SOLID WASTES AND EXTRACTING METALS AND METHODS THEREOF

(71) Applicant: HARBIN NORMAL UNIVERSITY, Harbin (CN)

(72) Inventors: Hanxi WANG, Harbin (CN); Shuang ZHAO, Harbin (CN); Yihanqi WANG, Harbin (CN)

(73) Assignee: HARBIN NORMAL UNIVERSITY, Harbin (CN)

(21) Appl. No.: 19/452,812

(22) Filed: Jan. 19, 2026

Related U.S. Application Data
(63) Continuation of application No. PCT/CN2025/090803, filed on Apr. 24, 2025.

(30) Foreign Application Priority Data
Jan. 8, 2025 (CN) 202510028576.7

(51) Int. Cl. C10B 57/02; B01D 45/16; B01D 45/18; B01D 47/02; B01D 47/06; B01D 50/40; B03C 3/017; C02F 11/10; C02F 101/20; C02F 103/20; C10B 53/00; C10B 53/07; C10B 57/10; C22B 7/00; C22B 21/00

(52) U.S. Cl. CPC C10B 57/02; B01D 45/16; B01D 45/18; B01D 47/021; B01D 47/06; B01D 50/40; B03C 3/017; C02F 11/10; C10B 53/00; C10B 53/07; C10B 57/10; C22B 7/001; C22B 21/0069; C02F 2101/20; C02F 2103/20

(57) ABSTRACT

An integrated device and a method thereof are provided. The integrated device includes: a pyrolysis chamber, a high-temperature cracking chamber, a material drying chamber, a steam boiler, a cyclonic dust removal chamber, a spray chamber, an electrostatic dust removal chamber, a water bath purification chamber, a biomass gas treatment chamber, and a metal carbonization chamber. The pyrolysis chamber is connected to the high-temperature cracking chamber. The pyrolysis chamber is provided with the first biomass air inlet. The high-temperature cracking chamber is provided with a second biomass air inlet and is connected to the material drying chamber through a lower hot air pipe and an upper hot air pipe. An air-drying cylinder is arranged in the material drying chamber. The upper hot air pipe is in communication with an interior of the air-drying cylinder. The lower hot air pipe is in communication with a space outside the air-drying cylinder.

### CROSS-REFERENCE TO RELATED APPLICATIONS

This application is a continuation of International Application No. PCT/CN2025/090803, filed on Apr. 24, 2025, which claims priority of Chinese patent Application No. 202510028576.7, filed on Jan. 8, 2025, the entire contents of each of which are incorporated herein by reference.

### TECHNICAL FIELD

The present disclosure generally relates to the field of environmental science and engineering, and in particular, to an integrated device for drying organic solid waste and extracting metals and a method thereof.

### BACKGROUND

Thermal energy conversion is a main form of utilization for organic solid waste. Pyrolysis recovery is an important form of metal extraction. Due to the complex components of organic solid waste, the gas generated during the drying process pollutes the environment. Traditional gas purification methods are costly, causing the utilization value of organic solid waste such as sludge, Chinese medicine residues, and livestock and poultry manure to be low. Traditional pyrolysis recovery methods for extracting metals from metal-containing organic waste generate a large amount of waste gas, and the treatment of the waste gas is difficult and costly. In particular, metal oxidation leads to low utilization rates. The mineral powder has low metal content while containing heavy metals, which makes metal extraction difficult and environmentally polluting. In particular, the safe treatment of heavy metals is highly challenging.

Currently, the thermal energy utilization rate of organic solid waste is low, the drying exhaust gas from organic solid wastes is difficult to treat, the metal recovery rate from metal-containing organic wastes is low, and the metal extraction from waste ore is difficult. Thus, these factors restrict the high-value utilization of organic solid waste and the efficient recovery of metals.

In view of the this, the present disclosure aims to provide an integrated device for drying organic solid waste and extracting metals and a method for using the integrated device, so as to solve the problems such as low thermal energy utilization rate of organic solid waste, large number of pollutants generated during the extraction process of metal-containing waste, high metal oxidation loss rate, and low carbonization efficiency of metal-containing organic waste.

### SUMMARY

To achieve the above objective, one or more embodiments of the present disclosure provide an integrated device for drying organic solid waste and extracting metals. The integrated device includes a pyrolysis chamber (1), a high-temperature cracking chamber (2), a material drying chamber (3), a steam boiler (4), a cyclonic dust removal chamber (5), a spray chamber (6), an electrostatic dust removal chamber (7), a water bath purification chamber (8), a biomass gas treatment chamber (9), and a metal carbonization chamber (10), wherein the pyrolysis chamber (1) is connected to the high-temperature cracking chamber (2) through an air passage port (26), a first biomass air inlet (16) is disposed on the pyrolysis chamber (1), a second biomass air inlet (37) is disposed on the high-temperature cracking chamber (2), and the high-temperature cracking chamber (2) is connected to the material drying chamber (3) through a lower hot air pipe (39) and an upper hot air pipe (40); an air-drying cylinder (41) is disposed in the material drying chamber (3), the upper hot air pipe (40) is in communication with an interior of the air-drying cylinder (41), the lower hot air pipe (39) is in communication with a space outside the air-drying cylinder (41), the space outside the air-drying cylinder (41) is in communication with the steam boiler (4) through a first connecting gas pipe (48), and the interior of the air-drying cylinder (41) is in communication with a discharge pipe (47); a hot air outlet (49) is disposed on the first connecting gas pipe (48), a first gas outlet (45) is disposed on the discharge pipe (47), a hot water inlet (50) is disposed on the steam boiler (4), and the steam boiler (4) is connected to the cyclonic dust removal chamber (5) through a second connecting gas pipe (52); a cyclonic exhaust pipe (54) is disposed in the cyclonic dust removal chamber (5), the cyclonic exhaust pipe (54) is connected to the spray chamber (6) through a third connecting gas pipe (56) an induced draft fan (55) is disposed on the third connecting gas pipe (56), the spray chamber (6) is connected to the electrostatic dust removal chamber (7) through a fourth connecting gas pipe (60), the electrostatic dust removal chamber (7) is connected to the water bath purification chamber (8) through a fifth connecting gas pipe (61), the water bath purification chamber (8) is connected to an exhaust pipe (68), and the exhaust pipe (68) is connected to the high-temperature cracking chamber (2) through a tail gas recovery pipe (70); a plurality of condenser tubes (87) are disposed in the biomass gas treatment chamber (9) in a transverse arrangement, one end of each condenser tube (87) is a gas inlet (88), and the other end is a gas passage port (92), the gas passage port (92) is connected to a drying chamber (94), and a second gas outlet (95) is disposed on the drying chamber (94); a water inlet (89) and a water outlet (93) are disposed on the biomass gas treatment chamber (9), the second gas outlet (95) is connected to the first biomass air inlet (16) through a gas return pipe (86), the gas inlet (88) is connected to the first gas outlet (45) through a first hot air inlet pipe (84), and the water outlet (93) is connected to the hot water inlet (50) through a first connecting water pipe (98); and a pyrolysis gas outlet (81) and a plurality of hot air inlets (83) are disposed on the metal carbonization chamber (10), the pyrolysis gas outlet (81) is connected to the second biomass air inlet (37) through a gas outlet pipe (85), and the plurality of hot air inlets (83) are connected to the hot air outlet (49) through a second hot air inlet pipe (107).

### BRIEF DESCRIPTION OF THE DRAWINGS

The drawings constitute a part of the present disclosure and are used to provide a further understanding of the present disclosure. The schematic embodiments of the present disclosure and the descriptions thereof are used to explain the present disclosure and do not constitute an improper limitation to the present disclosure. In the drawings:

FIG. 1 is a schematic diagram illustrating a vertical cross-sectional structure of an integrated device according to some embodiments of the present disclosure;

FIG. 2 is a schematic diagram illustrating a top-view structure of an integrated device according to some embodiments of the present disclosure;

FIG. 3 is a schematic diagram illustrating a vertical cross-sectional structure of a metal carbonization chamber according to some embodiments of the present disclosure; and

FIG. 4 is a schematic diagram illustrating a vertical cross-sectional structure of a biomass gas treatment chamber according to some embodiments of the present disclosure.

### DETAILED DESCRIPTION

The technical solutions in the embodiments of the present disclosure are clearly and completely described below with reference to the accompanying drawings in the embodiments of the present disclosure. It should be noted that, in the absence of conflict, the embodiments in the present disclosure and features in the embodiments may be combined with each other. The described embodiments are merely a part of the embodiments of the present disclosure, rather than all of the embodiments.

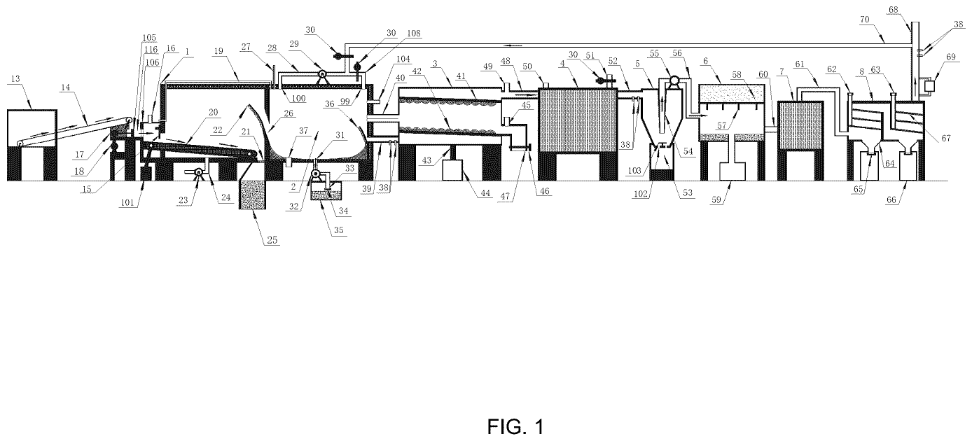

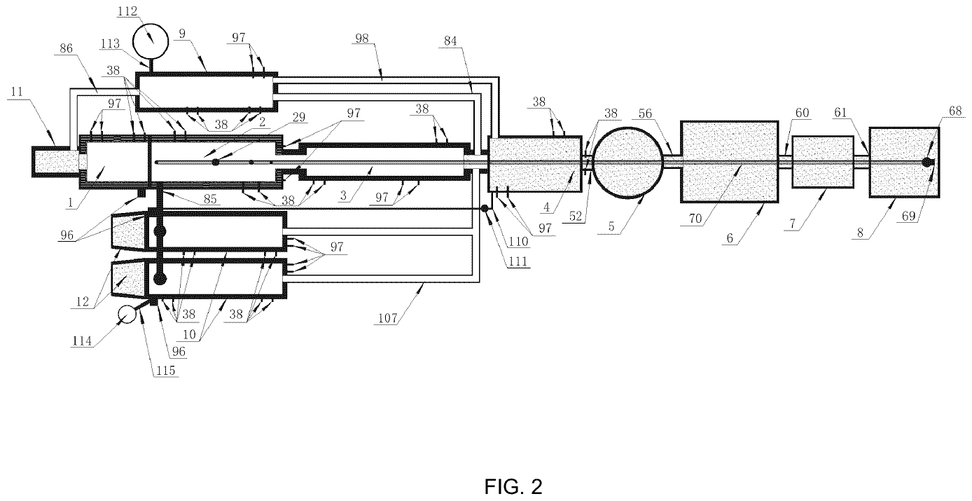

FIG. 1 is a schematic diagram illustrating a vertical cross-sectional structure of an integrated device according to some embodiments of the present disclosure. FIG. 2 is a schematic diagram illustrating a top view structure of the integrated device according to some embodiments of the present disclosure. As shown in FIG. 1 and FIG. 2, the integrated device includes a pyrolysis chamber 1, a high-temperature cracking chamber 2, a material drying chamber 3, a steam boiler 4, a cyclonic dust removal chamber 5, a spray chamber 6, an electrostatic dust removal chamber 7, a water bath purification chamber 8, a biomass gas treatment chamber 9, and a metal carbonization chamber 10.

The pyrolysis chamber 1 is connected to the high-temperature cracking chamber 2 through an air passage port 26. A first biomass air inlet 16 is disposed on the pyrolysis chamber 1. A second biomass air inlet 37 is disposed on the high-temperature cracking chamber 2. The high-temperature cracking chamber 2 is connected to the material drying chamber 3 through a lower hot air pipe 39 and an upper hot air pipe 40. An air-drying cylinder 41 is disposed in the material drying chamber 3. The upper hot air pipe 40 is in communication with an interior of the air-drying cylinder 41. The lower hot air pipe 39 is in communication with a space outside the air-drying cylinder 41. The space outside the air-drying cylinder 41 is connected to the steam boiler 4 through a first connecting gas pipe 48. The interior of the air-drying cylinder 41 is connected to a discharge pipe 47. A hot air outlet 49 is disposed on the first connecting gas pipe 48. A first gas outlet 45 is disposed on the discharge pipe 47.

A hot water inlet 50 is disposed on the steam boiler 4. The steam boiler 4 is connected to the cyclonic dust removal chamber 5 through a second connecting gas pipe 52. A cyclonic exhaust pipe 54 is disposed in the cyclonic dust removal chamber 5. The cyclonic exhaust pipe 54 is connected to the spray chamber 6 through a third connecting gas pipe 56. An induced draft fan 55 is disposed on the third connecting gas pipe 56. The spray chamber 6 is connected to the electrostatic dust removal chamber 7 through a fourth connecting gas pipe 60. The electrostatic dust removal chamber 7 is connected to the water bath purification chamber 8 through a fifth connecting gas pipe 61. The water bath purification chamber 8 is connected to an exhaust pipe 68. The exhaust pipe 68 is connected to the high-temperature cracking chamber 2 through a tail gas recovery pipe 70.

A condenser tube 87 is disposed in the biomass gas treatment chamber 9. A plurality of groups of the condenser tubes 87 are arranged horizontally. One end of the condenser tube 87 is a gas inlet 88. The other end of the condenser tube 87 is a gas passage port 92. The gas passage port 92 is connected to a drying chamber 94. A second gas outlet 95 is disposed on the drying chamber 94. A water inlet 89 and a water outlet 93 are disposed on the biomass gas treatment chamber 9. The second gas outlet 95 is connected to the first biomass air inlet 16 through a gas return pipe 86. The gas inlet 88 is connected to the first gas outlet 45 through a first hot air inlet pipe 84. The water outlet 93 is connected to the hot water inlet 50 through a first connecting water pipe 98. The horizontal direction refers to a direction parallel to the ground. The vertical direction refers to a direction perpendicular to the ground.

A pyrolysis gas outlet 81 and a hot air inlet 83 are disposed on the metal carbonization chamber 10. The pyrolysis gas outlet 81 is connected to the second biomass air inlet 37 through a gas outlet pipe 85. The hot air inlet 83 is connected to the hot air outlet 49 through a second hot air inlet pipe 107.

The pyrolysis chamber 1 is a chamber for performing preliminary decomposition on the organic solid waste. The pyrolysis chamber 1 is capable of heating the organic solid waste in an oxygen-deficient environment. Macromolecular organic matter in the organic solid waste undergoes pyrolysis and decomposes into solid waste residues, such as carbon residue and tar, and pyrolysis gas containing hydrogen, carbon monoxide, methane, low-carbon hydrocarbons (e.g., ethylene, ethane, or the like).

In some embodiments, the organic solid waste includes sludge, chicken manure, Chinese medicine residue, or the like. The organic solid waste may also include kitchen waste, waste paper residue, livestock and poultry slaughter waste, garden waste, or the like.

The high-temperature cracking chamber 2 is a chamber for performing deep decomposition on the organic solid waste. The high-temperature cracking chamber 2 is capable of performing high-temperature cracking treatment on the pyrolysis gas generated by the pyrolysis chamber 1. In a high-temperature and oxygen-rich environment, combustible components in the pyrolysis gas react with oxygen, release heat, and generate hot air.

The material drying chamber 3 is a chamber for pre-dehydrating the organic solid waste. In some embodiments, the organic solid waste consumed by the pyrolysis chamber 1 may not undergo pre-dehydration treatment and thus have a high-water content. The hot air generated by the high-temperature cracking chamber 2 is utilized as a heat source in the material drying chamber 3 to dry and dehydrate the organic solid waste. The dried and dehydrated organic solid waste is utilized as a raw material for the pyrolysis chamber 1.

The steam boiler 4 is a chamber for recovering waste heat resources. After the hot air dries and dehydrates the organic solid waste, the humidity of the hot air increases and the temperature of the hot air decreases. The hot air is unable to dry the organic solid waste again. At this time, the hot air tail gas discharged from the material drying chamber 3 is utilized to heat the steam boiler 4, so as to recover waste heat of the hot air tail gas, thereby improving thermal energy utilization efficiency of the integrated device.

The cyclonic dust removal chamber 5 is a chamber for performing primary purification on the hot air tail gas. Since the hot air tail gas contains a large number of particles such as dust and debris, it needs to undergo multi-stage purification through equipment such as the cyclonic dust removal chamber 5, and the tail gas can be discharged only after meeting the emission standards. The cyclonic dust removal chamber 5 may use centrifugal force to remove large-sized particles from the hot air tail gas.

The spray chamber 6 is a chamber for performing secondary purification on the hot air tail gas. The spray chamber 6 sprays a chemical agent solution, and the water mist of the chemical agent solution is fully mixed and contacted with the hot air tail gas, so as to remove medium-sized particles, aerosols, and acidic gases (e.g., NOx, SO₂, and HCl) from the hot air tail gas.

The electrostatic dust removal chamber 7 is a chamber for performing tertiary purification on the hot air tail gas. The electrostatic dust removal chamber 7 utilizes a high-voltage electric field to charge suspended particles in the hot air tail gas. The electrostatic dust removal chamber 7 captures the charged suspended particles and removes small-sized particles and metal oxide particles from the hot air tail gas through electrostatic adsorption.

The water bath purification chamber 8 is a chamber for performing quaternary purification on the hot air tail gas. The water bath purification chamber 8 is responsible for purification in the final stage. The water bath purification chamber 8 additionally removes residual particles, soluble gases, and aerosols from the hot air tail gas through full contact of tiny bubbles of the hot air tail gas with water.

The biomass gas treatment chamber 9 is a chamber for performing dehydration purification and waste heat recovery on the hot air tail gas. In some embodiments, when the organic solid waste is dried in the material drying chamber 3, the organic solid waste releases moisture and undergoes preliminary pyrolysis, releasing a portion of pyrolysis gas in advance, thereby causing the hot air tail gas in contact with the organic solid waste to be mixed with additional pyrolysis gas. Therefore, to improve the utilization efficiency of the pyrolysis gas, the biomass gas treatment chamber 9 may receive the hot air tail gas output from the inner side of the air-drying cylinder 41. The biomass gas treatment chamber 9 performs dehydration purification and waste heat recovery on the hot air tail gas, then returns the dried hot air tail gas to the pyrolysis chamber 1 for cyclic pyrolysis.

The metal carbonization chamber 10 is a chamber for performing carbonization treatment on metal-containing waste to recover metals. The metal carbonization chamber 10 is capable of using the hot air tail gas in the material drying chamber 3 that does not directly contact the organic solid waste to heat the metal-containing waste in the metal carbonization chamber 10. An organic portion of the metal-containing waste undergoes carbonization under high temperature to generate pyrolysis gas again. Residue mixed with metals undergoes subsequent collection, slag removal, and refining to recover the metals.

In some embodiments, the metal-containing waste includes, but is not limited to, aluminum-containing plastic waste, fabric metal zippers, electronic component waste, waste batteries, or the like.

More descriptions of the connection relationships and functions of the above-mentioned components may be found in later descriptions.

The air passage port 26 is a gas transmission channel connecting the pyrolysis chamber 1 and the high-temperature cracking chamber 2. The air passage port 26 transmits the pyrolysis gas generated in the pyrolysis chamber 1 to the high-temperature cracking chamber 2.

The first biomass air inlet 16 is a gas input port disposed on the pyrolysis chamber 1. The first biomass air inlet 16 is in communication with the second gas outlet 95 of the biomass gas treatment chamber 9 through the gas return pipe 86, so that the pyrolysis chamber 1 can receive the dried pyrolysis gas from the biomass gas treatment chamber 9.

The second biomass air inlet 37 is a gas input port disposed on the high-temperature cracking chamber 2. The second biomass air inlet 37 is in communication with the pyrolysis gas outlet 81 of the metal carbonization chamber 10 through the gas outlet pipe 85, so that the high-temperature cracking chamber 2 can receive the pyrolysis gas from the metal carbonization chamber 10.

The lower hot air pipe 39 and the upper hot air pipe 40 are hot air delivery pipes connecting the high-temperature cracking chamber 2 and the material drying chamber 3.

Both one end of the lower hot air pipe 39 and one end of the upper hot air pipe 40 are in communication with a hot air outlet area of the high-temperature cracking chamber 2, and the only difference is that the other end of the lower hot air pipe 39 is in communication with the space outside the air-drying cylinder 41 in the material drying chamber 3 to heat an outside of the air-drying cylinder 41, thereby indirectly dehydrating the organic solid waste in the air-drying cylinder 41, while the other end of the upper hot air pipe 40 is in communication with the interior space of the air-drying cylinder 41 in the material drying chamber 3 to directly dehydrate the organic solid waste in the air-drying cylinder 41.

In some embodiments, a pyrolysis chamber feed inlet 116 is disposed on a side of the pyrolysis chamber 1. A first ash discharge port 21 is disposed on a bottom surface of the pyrolysis chamber 1. The first ash discharge port 21 is gravity-sensing openable and closable.

The pyrolysis chamber feed inlet 116 is a material input port of the pyrolysis chamber 1. The organic solid waste for pyrolysis is continuously supplemented into the pyrolysis chamber 1 through the pyrolysis chamber feed inlet 116, providing raw materials for the pyrolysis process.

In some embodiments, the pyrolysis chamber feed inlet 116 is connected to the discharge valve 46. The pyrolysis chamber feed inlet 116 receives the organic solid waste dried and dehydrated by the discharge valve 46 to ensure continuous feeding of the pyrolysis chamber 1.

The first ash discharge port 21 is a waste slag discharge port of the pyrolysis chamber 1. The first ash discharge port 21 discharges solid waste slag, such as carbon residue and tar generated after pyrolysis of the organic solid waste in the pyrolysis chamber 1.

In some embodiments, the first ash discharge port 21 is gravity-sensing openable and closable. When the waste slag accumulates to a preset weight, the first ash discharge port 21 automatically opens. The waste slag falls into the slag storage tank 25 below by gravity. Subsequently, the first ash discharge port 21 closes. The preset weight may be determined based on actual needs.

In some embodiments, a grate 20 is arranged in the pyrolysis chamber 1, and the grate 20 is connected to the third speed reducer 101. One end of the grate 20 is arranged at the pyrolysis chamber feed inlet 116, and the other end is proximate to the first ash discharge port 21.

The grate 20 is a component in the pyrolysis chamber 1 that carries and pyrolyzes the organic solid waste. The structure of the grate 20 is similar to a heatable conveyor belt. The grate 20 uniformly carries and heats the organic solid waste to be pyrolyzed. Driven by the third speed reducer 101, the grate 20 slowly transports the organic solid waste to the first ash discharge port 21, thereby achieving continuous pyrolysis and slag discharge of the organic solid waste.

The third speed reducer 101 is a power component that drives the operation of the grate 20. The third speed reducer 101 is configured to adjust a conveying speed of the grate 20.

In some embodiments, a slag storage tank 25 is disposed below the first ash discharge port 21, water is contained in the slag storage tank 25 with a water level at 30%-50% of the depth of the slag storage tank 25, and the slag storage tank 25 is connected to a slag remover 96.

The slag storage tank 25 is a tank body for temporarily storing waste slag. The slag storage tank 25 receives high-temperature waste slag discharged from the first ash discharge port 21. The slag storage tank 25 utilizes water in the tank to cool the waste slag, to prevent dust and secondary combustion of the waste slag.

In some embodiments, the slag storage tank 25 is connected to the slag remover 96. The slag remover 96 transports the cooled waste slag in the slag storage tank 25 to an external location (e.g., a waste slag landfill), thereby achieving automated removal of the waste slag.

In some embodiments, the first ash discharge port 21 is gravity-sensing openable and closable. When the waste slag exceeds 5 kg, the first ash discharge port 21 automatically opens. After discharging the material, the first ash discharge port 21 automatically closes. The waste slag in the slag storage tank 25 is discharged by the slag remover 96 and then collected for external transportation.

In some embodiments, the water level may also be one of 30%, 35%, 40%, 45%, or 50% of the depth of the slag storage tank 25.

In some embodiments, the water level may also be in a range of 30%-35%, 35%-40%, 40%-45%, 45%-50%, 30%-40%, 35%-45%, 40%-50%, or 30%-50% of the depth of the slag storage tank 25.

In some embodiments, a first dust suppression plate 22 is disposed in the pyrolysis chamber 1, the first dust suppression plate 22 is located at the air passage port 26, the first dust suppression plate 22 has an arched structure, and a tangent of the arched structure forms an angle of 55°-80° with a horizontal direction.

The first dust suppression plate 22 is a dust interception component in the pyrolysis chamber 1. The first dust suppression plate 22 is arranged at the air passage port 26. Since the pyrolysis gas contains a large amount of dust, which easily causes pipe blockage, the first dust suppression plate 22 is required to intercept the dust in the pyrolysis gas, thus ensuring the operational stability of subsequent equipment.

In some embodiments, as shown in FIG. 1, the first dust suppression plate 22 adopts the arched structure. The bottom of the first dust suppression plate 22 fits a side wall of the pyrolysis chamber 1. The top of the first dust suppression plate 22 forms an opening for gas to pass through.

In some embodiments, a tangent at the top portion of the first dust suppression plate is defined as an arch tangent. An angle between the arch tangent and the horizontal direction is in a range of 55°-80°.

In some embodiments, the angle between the arch tangent of the first dust suppression plate 22 and the horizontal direction may also be one of 55°, 60°, 65°, 70°, 75°, or 80°.

In some embodiments, the angle between the arch tangent of the first dust suppression plate 22 and the horizontal direction may also be in a range of 55-60°, 60-65°, 65-70°, 70-75°, 75-80°, 55-65°, 60-70°, or 65-80°.

In some embodiments, the first dust suppression plate 22 arranged in the pyrolysis chamber 1 may enhance the collision and sedimentation effect of dust, so as to enable the dust to slide down along the surface of the arched plate and reduce powder entering the high-temperature cracking chamber 2, thereby improving the dust-lowering efficiency.

In some embodiments, the pyrolysis chamber 1 is connected to the first feeding system 11. The first feeding system 11 includes the first storage bin 13, the first feeder 14, and the material pushing system 17.

The first feeding system 11 is an automated feeding system for adding organic solid waste into the pyrolysis chamber 1. In some embodiments, one end of the first feeder 14 is arranged inside the first storage bin 13, and the other end of the first feeder 14 is arranged above the material pushing system 17. The material pushing system 17 is located at the pyrolysis chamber feed inlet 116. The material pushing system 17 is connected to the motor 18. The positioning plate 15 is arranged at the pyrolysis chamber feed inlet 116.

The first storage bin 13 is configured to store the organic solid waste. The positioning plate 15 is configured to adjust the spreading thickness of the organic solid waste on the grate to ensure uniform distribution of the organic solid waste. A smaller gap between the positioning plate 15 and the grate 20 results in a thinner thickness of the organic solid waste.

In some embodiments, during the operation of the pyrolysis chamber 1, the first feeder 14 conveys the organic solid waste from the first storage bin 13 to be above the material pushing system 17. The organic solid waste falls into the material pushing system 17. Pushed by the motor 18, a push plate 105 at the front end of the material pushing system 17 pushes the organic solid waste into the pyrolysis chamber feed inlet 116. The organic solid waste falls onto the grate 20. When the grate 20 moves, the organic solid waste is conveyed to a gap between the grate 20 and the positioning plate 15. Under a physical limiting action of the positioning plate 15, the organic solid waste is forcibly spread and thinned, and forms a uniformly distributed thin-layer structure. Subsequently, the organic solid waste begins pyrolysis.

In some embodiments, a cover plate 106 is arranged above the positioning plate 15. The cover plate 106 is connected to the pyrolysis chamber 1. The first biomass air inlet 16 is arranged on the cover plate 106. The front end of the material pushing system 17 is the push plate 105. After the push plate 105 is extended, the push plate 105 closes to seal against the cover plate 106.

The cover plate 106 is a sealing structure of the pyrolysis chamber 1.

In some embodiments, because the organic solid waste needs to be heated in the pyrolysis chamber 1, when adding the organic solid waste, high-temperature airflow in the pyrolysis chamber 1 may reverse leak from the pyrolysis chamber feed inlet 116, which causes dust flying and combustible gas escape. Therefore, it is necessary to arrange the cover plate 106 with a matching shape and size above the positioning plate 15. When the push plate 105 is extended, the push plate 105 closes to seal against the cover plate 106, so as to block a path for reverse leakage of the high-temperature airflow from the feed port, ensuring stable operation of the material pushing system 17.

In some embodiments, by adjusting a width of the gap between the positioning plate 15 and the grate 20, a spreading thickness of the organic solid waste can be precisely controlled, so as to ensure that the organic solid waste is heated uniformly on the grate, which effectively avoids phenomena such as insufficient local pyrolysis or excessive carbonization, thereby improving pyrolysis efficiency of the pyrolysis chamber 1 and carbonization quality of the organic solid waste.

In some embodiments, a primary air duct 24 is arranged at the bottom of the pyrolysis chamber 1. A primary air fan 23 is connected to the primary air duct 24. An air volume of the primary air fan 23 is in a range of 2000-6000 m³/(ton·hour) of the organic solid waste.

The primary air fan 23 is a fan that pumps air into the pyrolysis chamber 1. The primary air fan 23 provides oxygen for the pyrolysis of the organic solid waste.

In some embodiments, the air volume of the primary air fan 23 may also be one of 2000 m³/(ton·hour), 3000 m³/(ton·hour), 4000 m³/(ton·hour), 5000 m³/(ton·hour), or 6000 m³/(ton·hour) of the organic solid waste.

In some embodiments, the air volume of the primary air fan 23 may also be in a range of 2000-3000 m³/(ton·hour), 2000-4000 m³/(ton·hour), 3000-4000 m³/(ton·hour), 3000-5000 m³/(ton·hour), 4000-5000 m³/(ton·hour), 4000-6000 m³/(ton·hour), 5000-6000 m³/(ton·hour), or 2000-5000 m³/(ton·hour) of the organic solid waste.

In some embodiments, an oxygen inlet pipe 19 is arranged on the top surface of the high-temperature cracking chamber 2. Gas with an oxygen content exceeding 70% is introduced into the oxygen inlet pipe 19.

The oxygen inlet pipe 19 is a pipe that pumps oxygen-enriched gas into the high-temperature cracking chamber 2. The oxygen inlet pipe 19 provides high-concentration oxygen for the cracking of pyrolysis gas.

In some embodiments, the oxygen content of the gas introduced into the oxygen inlet pipe 19 may also be one of 70%, 75%, 80%, 85%, 90%, 95%, or 100%.

In some embodiments, the oxygen content of the gas introduced into the oxygen inlet pipe 19 may also be in a range of 70%-80%, 70%-85%, 75%-85%, 75%-90%, 80%-90%, 80%-95%, 85%-95%, 85%-100%, 90%-100%, 70%-90%, or 75%-100%.

In some embodiments, the primary air duct 24 arranged at the bottom of the pyrolysis chamber 1 helps supplement air into the pyrolysis chamber 1. The oxygen inlet pipe 19 arranged on the top surface of the high-temperature cracking chamber 2 helps supplement high-concentration oxygen into the high-temperature cracking chamber 2.

In some embodiments, the outer side of the pyrolysis chamber 1 and the outer side of the high-temperature cracking chamber 2 are made of steel plates. From outside to inside, fire-resistant cotton, fire-resistant insulation bricks, a fire-resistant cement coating, and fire-resistant paint are sequentially arranged.

In some embodiments, the fire-resistant cotton may include aluminum silicate fiber cotton, alumina fiber cotton, or the like. The fire-resistant insulation bricks may include clay fire bricks, silicon carbide fire bricks, or the like. The fire-resistant cement coating may include aluminate cement coating, dolomite cement coating, or the like. The fire-resistant paint may include aluminum silicate fire-resistant paint, silicon carbide fire-resistant paint, etc.

In some embodiments, by sequentially arranging the fire-resistant cotton, the fire-resistant insulation bricks, the fire-resistant cement coating, and the fire-resistant paint from outside to inside on the outer steel plates of the pyrolysis chamber 1 and the high-temperature cracking chamber 2, heat loss from the pyrolysis chamber 1 and the high-temperature cracking chamber 2 can be reduced, fuel consumption can also be reduced.

In some embodiments, a bottom surface of the high-temperature cracking chamber 2 is provided with a second ash discharge port 31. The second ash discharge port 31 is connected to an ash discharge pipe 33 through an ash cleaning fan 32 at a lower side of the second ash discharge port 31. An outlet end of the ash discharge pipe 33 is arranged in an ash storage box 35. The outlet end of the ash discharge pipe 33 is connected to an ash cover 34 through a spring.

The second ash discharge port 31 is a dust removal outlet of the high-temperature cracking chamber 2. The second ash discharge port 31 is configured to discharge dust and other particulate matter in the high-temperature cracking chamber 2.

In some embodiments, the ash cleaning fan 32 performs ash cleaning once every 6-12 hours. The outlet end of the ash discharge pipe 33 is arranged in the ash storage box 35. The outlet end of the ash discharge pipe 33 is connected to the ash cover 34 through a spring. The ash cover 34 opens only during ash cleaning to discharge dust into the ash storage box 35. The ash cover 34 closes after ash cleaning to prevent dust from escaping.

In some embodiments, a second dust suppression plate 36 is arranged in the high-temperature cracking chamber 2. The second dust suppression plate 36 is located at a lower side of the lower hot air pipe 39. The second dust suppression plate 36 has an arched structure. A tangent of the arched structure forms an angle of 65°-85° with the horizontal direction.

The second dust suppression plate 36 is a dust interception component of the high-temperature cracking chamber 2. A function and a shape of the second dust suppression plate 36 are similar to a function and a shape of the first dust suppression plate 22. The second dust suppression plate 36 and the first dust suppression plate 22 both have an arched structure. The bottom of the second dust suppression plate 36 fits against a side wall of the high-temperature cracking chamber 2. A top of the second dust suppression plate 36 and the lower hot air pipe 39 have an opening therebetween for gas to pass through.

In some embodiments, the tangent of the arched structure of the second dust suppression plate 36 forms an angle of 65°, 70°, 75°, 80°, or 85° with the horizontal direction.

In some embodiments, the tangent of the arched structure of the second dust suppression plate 36 forms an angle of 65°-70°, 70°-75°, 75°-80°, 80°-85°, 65°-75°, 70°-80°, 75°-85°, or 65°-80° with the horizontal direction.

In some embodiments, by providing the second ash discharge port 31 and other devices, accumulated dust in the high-temperature cracking chamber 2 can be discharged in a timely manner, thus preventing blockages caused by the accumulated dust from affecting the cracking reaction efficiency. By providing the second dust suppression plate 36, dust entering the material drying chamber 3 can be reduced, thereby improving dust-lowering efficiency.

In some embodiments, a side surface of the high-temperature cracking chamber 2 is provided with an additive inlet 104. A top surface of the high-temperature cracking chamber 2 is provided with a combustion accelerator inlet 27, a self-circulation outlet 99, and a self-circulation inlet 100. The self-circulation inlet 100 is arranged on a side close to the pyrolysis chamber 1. The self-circulation outlet 99 is arranged on a side close to the material drying chamber 3. A tail gas recovery pipe 70 is connected to the self-circulation inlet 100 through an air intake pipe 28. The tail gas recovery pipe 70 is connected to the self-circulation outlet 99 through an air exhaust pipe 108. The air intake pipe 28 is provided with a secondary air fan 29. The tail gas recovery pipe 70 and the air exhaust pipe 108 are each provided with an airflow control valve 30.

The additive inlet 104 and the combustion accelerator inlet 27 are both feeding ports of the high-temperature cracking chamber 2. The additive inlet 104 and the combustion accelerator inlet 27 are configured to supplement an additive and a combustion accelerator, respectively, into the high-temperature cracking chamber 2. Specific types of the additive and the combustion accelerator may be determined based on actual needs.

In some embodiments, a biomass additive is added through the combustion accelerator inlet 27. The biomass additive is a solid powder fuel with a calorific value greater than 8000 kcal/kg.

The biomass additive is a solid powder prepared from biological raw materials. For example, the biomass additive includes charcoal powder, coconut shell charcoal powder, or the like.

In some embodiments, an additive is added through the additive inlet 104. The additive is a mixture of modified wood-based biochar, glass fiber reinforced plastic powder, calcium sulfate, diatomaceous earth, ceramic powder, and activated carbon. A mixing ratio of the modified wood-based biochar, the glass fiber reinforced plastic powder, the calcium sulfate, the diatomaceous earth, the ceramic powder, and the activated carbon is 1:(0.03-0.1):(0.01-0.05):(0.03-0.08):(0.1-0.15):(0.12-0.25).

The modified wood-based biochar is a product obtained by modifying charcoal with a chemical reagent. The modification may include phosphoric acid modification, potassium permanganate modification, zinc nitrate modification, or the like.

In some embodiments, the additive comprises 1 part of modified wood-based biochar, the glass fiber reinforced plastic powder is in a range of 0.03-0.1 parts, the calcium sulfate is in a range of 0.01-0.05 parts, the diatomaceous earth is in a range of 0.03-0.08 parts, the ceramic powder is in a range of 0.1-0.15 parts, and the activated carbon is in a range of 0.12-0.25 parts.

In some embodiments, the additive comprises 1 part of modified wood-based biochar. The parts of the glass fiber reinforced plastic powder may be one of 0.03 parts, 0.04 parts, 0.05 parts, 0.06 parts, 0.07 parts, 0.08 parts, or 0.1 parts. The parts of the calcium sulfate may be one of 0.01 parts, 0.02 parts, 0.03 parts, 0.04 parts, or 0.05 parts. The parts of the diatomaceous earth may be one of 0.03 parts, 0.04 parts, 0.05 parts, 0.06 parts, 0.07 parts, or 0.08 parts. The parts of the ceramic powder may be one of 0.1 parts, 0.11 parts, 0.12 parts, 0.13 parts, 0.14 parts, or 0.15 parts. The parts of the activated carbon may be one of 0.12 parts, 0.15 parts, 0.18 parts, 0.21 parts, 0.24 parts, or 0.25 parts.

In some embodiments, the additive comprises 1 part of modified wood-based biochar. The parts of the glass fiber reinforced plastic powder may be in a range of 0.03-0.06 parts, 0.04-0.07 parts, 0.05-0.08 parts, 0.06-0.1 parts, 0.03-0.07 parts, 0.04-0.09 parts, or 0.05-0.1 parts. The parts of the calcium sulfate may be in a range of 0.01-0.03 parts, 0.02-0.04 parts, 0.03-0.05 parts, 0.01-0.04 parts, or 0.02-0.05 parts. The parts of the diatomaceous earth may be in a range of 0.03-0.05 parts, 0.04-0.06 parts, 0.05-0.07 parts, 0.06-0.08 parts, 0.03-0.06 parts, 0.04-0.07 parts, or 0.05-0.08 parts. The parts of the ceramic powder may be in a range of 0.1-0.12 parts, 0.11-0.13 parts, 0.12-0.14 parts, 0.13-0.15 parts, 0.1-0.13 parts, 0.11-0.14 parts, or 0.12-0.15 parts. The parts of the activated carbon may be in a range of 0.12-0.15 parts, 0.15-0.18 parts, 0.18-0.21 parts, 0.21-0.25 parts, 0.12-0.18 parts, 0.15-0.21 parts, or 0.18-0.25 parts.

In some embodiments, particle sizes of the modified wood-based biochar, the glass fiber reinforced plastic powder, the calcium sulfate, the diatomaceous earth, the ceramic powder, and the activated carbon are in a range of 0.2-1.0 mm, 0.1-0.5 mm, 0.05-0.1 mm, 0.25-1.0 mm, 0.05-0.5 mm, and 0.1-2.0 mm, respectively. The modified wood-based biochar is a mixture of ferric chloride-modified biochar and NaOH-modified biochar. A mixing ratio of the ferric chloride-modified biochar and the NaOH-modified biochar is in a range of 1:(0.5-0.8). A modifier concentration of ferric chloride is in a range of 0.01-0.1 mol/L. A modifier concentration of NaOH is in a range of 0.01-0.05 mol/L. Modification times for the ferric chloride-modified biochar and the NaOH-modified biochar are both 24-72 hours. The activated carbon is coal-based activated carbon, an iodine adsorption value on a dry basis of the coal-based activated carbon is greater than 400 mg/g, and a sulfate ash content on a dry basis of the coal-based activated carbon is less than 7%.

In some embodiments, the particle size of the modified wood-based biochar may be 0.2 mm, 0.4 mm, 0.6 mm, 0.8 mm, or 1.0 mm. The particle size of the glass fiber reinforced plastic powder may be 0.1 mm, 0.2 mm, 0.3 mm, 0.4 mm, or 0.5 mm. The particle size of the calcium sulfate may be 0.05 mm, 0.07 mm, 0.09 mm, or 0.1 mm. The particle size of the diatomaceous earth may be 0.25 mm, 0.45 mm, 0.65 mm, 0.85 mm, or 1.0 mm. The particle size of the ceramic powder may be 0.05 mm, 0.15 mm, 0.25 mm, 0.35 mm, 0.45 mm, or 0.5 mm. The particle size of the activated carbon may be 0.1 mm, 0.5 mm, 1.0 mm, 1.5 mm, or 2.0 mm. The mixing ratio of the ferric chloride-modified biochar and the NaOH-modified biochar may be 1:0.5, 1:0.6, 1:0.7, or 1:0.8. The modifier concentration of ferric chloride may be 0.01 mol/L, 0.03 mol/L, 0.05 mol/L, 0.07 mol/L, 0.09 mol/L, or 0.1 mol/L. The modifier concentration of NaOH may be 0.01 mol/L, 0.02 mol/L, 0.03 mol/L, 0.04 mol/L, or 0.05 mol/L. The modification time may be 24 hours, 36 hours, 48 hours, 60 hours, or 72 hours.

In some embodiments, the particle size of the modified wood-based biochar may be in a range of 0.2-0.5 mm, 0.4-0.7 mm, 0.6-1.0 mm, 0.2-0.6 mm, or 0.5-1.0 mm. The particle size of the glass fiber reinforced plastic powder may be in a range of 0.1-0.3 mm, 0.2-0.4 mm, 0.3-0.5 mm, 0.1-0.4 mm, or 0.2-0.5 mm. The particle size of the calcium sulfate may be in a range of 0.05-0.07 mm, 0.06-0.08 mm, 0.07-0.1 mm, 0.05-0.08 mm, or 0.06-0.1 mm. The particle size of the diatomaceous earth may be in a range of 0.25-0.5 mm, 0.4-0.7 mm, 0.6-1.0 mm, 0.25-0.6 mm, or 0.5-1.0 mm. The particle size of the ceramic powder may be in a range of 0.05-0.2 mm, 0.15-0.3 mm, 0.25-0.4 mm, 0.35-0.5 mm, 0.05-0.3 mm, or 0.2-0.5 mm. The particle size of the activated carbon may be in a range of 0.1-0.7 mm, 0.5-1.2 mm, 1.0-1.8 mm, 0.1-1.0 mm, or 0.8-2.0 mm. The mixing ratio of the ferric chloride-modified biochar and the NaOH-modified biochar may be in a range of 1:(0.5-0.65), 1:(0.6-0.75), 1:(0.7-0.8), 1:(0.5-0.7), or 1:(0.6-0.8). The modifier concentration of ferric chloride may be in a range of 0.01-0.04 mol/L, 0.03-0.06 mol/L, 0.05-0.08 mol/L, 0.07-0.1 mol/L, 0.01-0.05 mol/L, or 0.04-0.1 mol/L. The modifier concentration of NaOH may be in a range of 0.01-0.04 mol/L, 0.02-0.05 mol/L, 0.01-0.03 mol/L, 0.03-0.05 mol/L, or 0.02-0.04 mol/L. The modification time may be in a range of 24-40 hours, 36-52 hours, 48-64 hours, 56-72 hours, 24-48 hours, or 40-72 hours.

In some embodiments, the activated carbon is coal-based activated carbon. An iodine adsorption value on a dry basis of the coal-based activated carbon is greater than 400 mg/g. A sulfate ash content on a dry basis of the coal-based activated carbon is less than 7%.

The coal-based activated carbon is a porous carbon material prepared from coal as a raw material through processes such as carbonization and activation. In some embodiments, the iodine adsorption value of the coal-based activated carbon is greater than 400 mg/g. The sulfate ash content of the coal-based activated carbon is less than 7%.

In some embodiments, the iodine adsorption value of the coal-based activated carbon may be greater than 450 mg/g, greater than 500 mg/g, greater than 550 mg/g, greater than 600 mg/g, etc.

In some embodiments, the sulfate ash content of the coal-based activated carbon may be 0%, 1%, 2%, 3%, 4%, 5%, 6%, or 7%. The sulfate ash content of the coal-based activated carbon may be 0-3%, 2%-5%, 4%-7%, 0-4%, 3%-7%, or 1%-6%.

In some embodiments, using a biomass additive with a calorific value >8000 kcal/kg can improve combustion efficiency, enhance a drying effect on organic solid waste, and reduce energy consumption. Using a composite additive with a specific ratio can inhibit resynthesis of dioxins and reduce tail gas purification costs.

The self-circulation outlet 99 and the self-circulation inlet 100 are an outlet and an inlet, respectively, for hot air circulation in the high-temperature cracking chamber 2. The self-circulation inlet 100 is arranged on a side close to the pyrolysis chamber 1. The self-circulation outlet 99 is arranged on a side close to the material drying chamber 3.

In some embodiments, when hot air circulation is required, the secondary air fan 29 starts. The secondary air fan 29 draws hot air from the high-temperature cracking chamber 2 through the air intake pipe 28, and draws a portion of tail gas to be discharged from the exhaust pipe 68 through the tail gas recovery pipe 70, so as to mix the hot air and the tail gas, and then discharge the mixture to the high-temperature cracking chamber 2 through the air exhaust pipe 108, thereby achieving hot air circulation.

In some embodiments, the tail gas recovery pipe 70 and the air exhaust pipe 108 are each provided with the airflow control valve 30. By controlling an opening degree of the airflow control valve 30, a ratio of tail gas to an air volume of the high-temperature cracking chamber 2 may be controlled.

In some embodiments, for the secondary air fan 29, the ratio of the air volume from tail gas to that from the high-temperature cracking chamber 2 is in a range of 1:(0.1-0.3).

In some embodiments, for the secondary air fan 29, the ratio of the air volume from tail gas to that from the high-temperature cracking chamber 2 may be one of 1:0.1, 1:0.15, 1:0.2, 1:0.25, or 1:0.3.

In some embodiments, for the secondary air fan 29, the ratio of the air volume from tail gas to that from the high-temperature cracking chamber 2 may be in a range of 1:(0.1-0.2), 1:(0.15-0.25), 1:(0.2-0.3), 1:(0.1-0.25), or 1:(0.15-0.3).

In some embodiments, by providing the secondary air fan 29 on the air intake pipe 28, the tail gas can be recycled through the secondary air fan 29, thereby improving energy efficiency. By setting the secondary air volume ratio to be 1:(0.1-0.3), the ratio of tail gas recovery to the air volume of the high-temperature cracking chamber can be optimized, energy utilization can be improved, and tail gas emissions can be reduced.

The air-drying cylinder 41 is a drum-shaped component configured to carry and dry organic solid waste. The air-drying cylinder 41 achieves dehydration and drying of organic solid waste to be dried through direct dehydration by hot air inside the air-drying cylinder 41 and indirect dehydration by hot air outside the air-drying cylinder 41.

The first connecting gas pipe 48 is a gas transmission pipeline connecting an outer side of the air-drying cylinder 41 to the steam boiler 4. One end of the first connecting gas pipe 48 is in communication with an outer side space of the air-drying cylinder 41, and the other end is in communication with a hot air input end of the steam boiler 4. The first connecting gas pipe 48 conveys hot air tail gas from the outer side of the air-drying cylinder 41 to the steam boiler 4, thereby achieving waste heat recovery and utilization.

The discharge pipe 47 is a material discharge port of the air-drying cylinder 41. One end of the discharge pipe 47 is in communication with an internal discharge port of the air-drying cylinder 41, and a discharge valve 46 is disposed on the other end of the discharge pipe 47. The discharge pipe 47 is configured to discharge dried organic solid waste from the air-drying cylinder 41.

In some embodiments, a plurality of blades 42 are disposed inside the air-drying cylinder 41, a dust removal outlet 43 is disposed at a lower portion of the material drying chamber 3, the dust removal outlet 43 is connected to a dust storage tank 44, and a discharge valve 46 is disposed on the discharge pipe 47.

The blade 42 is a stirring component arranged inside the air-drying cylinder 41. During a process of drying organic solid waste by the air-drying cylinder 41, the blades 42 stir material through rotation, causing organic solid waste to be dried to fully contact hot air, preventing the organic solid waste from agglomerating, and improving drying uniformity and efficiency.

The dust removal outlet 43 is a dust removal outlet arranged at the lower part of the material drying chamber 3. Because hot air tail gas outside the air-drying cylinder 41 carries a large count of dust and debris, the dust and debris gradually deposit in the material drying chamber 3 during a prolonged drying process. The dust removal outlet 43 is connected to the dust storage tank 44. The dust removal outlet 43 conveys collected dust and debris to the dust storage tank 44 for temporary storage.

The discharge valve 46 is a flow control valve disposed at the end of the discharge pipe 47. The discharge valve 46 is configured to control a discharge rate of the dried organic solid waste from the air-drying cylinder 41. The discharge valve 46 prevents premature discharge of material to be dried, and prevents dried material from accumulating in the air-drying cylinder 41.

In some embodiments, by disposing the blades 42 inside the air-drying cylinder 41, the organic solid waste can fully contact with the hot air, thereby improving the uniformity of drying and thermal energy utilization efficiency. By disposing a dust removal outlet 43 at a lower portion of the material drying chamber 3, and connecting the dust removal outlet 43 to the dust storage tank 44, dust and debris generated during the drying process can be collected and temporarily stored in a timely manner, ensuring the smooth circulation of hot air. By disposing a discharge valve 46 on the discharge pipe 47, the discharge rate can be precisely controlled, which ensures that the material is discharged in an orderly manner after being fully dried.

The hot air outlet 49 is a hot air diversion component disposed on the first connecting gas pipe 48. One end of the hot air outlet 49 is connected to the first connecting gas pipe 48 through a bypass, and the other end of the hot air outlet 49 is connected to the hot air inlet 83 of the metal carbonization chamber 10 through the second hot air inlet pipe 107. The hot air outlet 49 draws a portion of the hot air tail gas from the first connecting gas pipe 48. The hot air outlet 49 utilizes the portion of hot air tail gas as a heat source for a carbonization process in the metal carbonization chamber 10.

The first gas outlet 45 is a gas outlet on the discharge pipe 47. One end of the first gas outlet 45 is connected to the discharge pipe 47, and the other end of the first gas outlet 45 is connected to the gas inlet 88 of the biomass gas treatment chamber 9 through the first hot air inlet pipe 84. During drying of the organic solid waste in the material drying chamber 3, hot air tail gas contacting the organic solid waste is mixed with additional pyrolysis gas. The first gas outlet 45 extracts and conveys the hot air tail gas mixed with the pyrolysis gas to the biomass gas treatment chamber 9 for cyclic pyrolysis.

The hot water inlet 50 is a water inlet arranged on the steam boiler 4. One end of the hot water inlet 50 is in communication with a cavity of the steam boiler 4, and the other end of the hot water inlet 50 is connected to the water outlet 93 of the biomass gas treatment chamber 9 through the first connecting water pipe 98. The biomass gas treatment chamber 9 cools the hot air tail gas in the condenser tube 87 and heats circulating water through water circulation heat exchange. The heated circulating water enters the steam boiler 4 through the hot water inlet 50, and serves as a water source for the steam boiler 4.

The second connecting gas pipe 52 is a gas transmission pipeline connecting the steam boiler 4 and the cyclonic dust removal chamber 5. One end of the second connecting gas pipe 52 is in communication with a tail gas outlet of the steam boiler 4, and the other end is in communication with an air inlet of the cyclonic dust removal chamber 5. The second connecting gas pipe 52 conveys low-temperature hot air tail gas after waste heat recovery from the steam boiler 4 to the cyclonic dust removal chamber 5 for dust removal treatment.

In some embodiments, the steam boiler 4 includes a steam outlet 51 disposed at a top of the steam boiler 4, and an airflow control valve 30 is disposed on the steam outlet 51.

The steam outlet 51 may discharge high-temperature steam generated in the steam boiler 4. The airflow control valve 30 is a flow valve disposed on the steam outlet 51. The airflow control valve 30 is configured to adjust a steam output flow rate of the steam outlet 51. When the pressure of the steam boiler 4 is abnormally high, the airflow control valve 30 may also be used for emergency pressure relief.

In some embodiments, by disposing the steam outlet 51 at the top of the steam boiler 4, and disposing an airflow control valve 30 on the steam outlet 51, the airflow control valve 30 can precisely adjust the steam output flow rate according to downstream steam demand, and can also quickly relieve pressure when the pressure of the steam boiler 4 is abnormal, effectively avoiding an overpressure risk.

The cyclonic exhaust pipe 54 is a core component inside the cyclonic dust removal chamber 5.

In some embodiments, a dust settling hole 102 is disposed at the bottom of the cyclonic dust removal chamber 5 and located in an ash storage bucket 53; a dust baffle plate 103 is disposed above the dust settling hole 102; and the cyclonic exhaust pipe 54 has a structure with a larger upper portion and a smaller lower portion.

In some embodiments, as shown in FIG. 1, the cyclonic exhaust pipe 54 has a structure with a larger upper portion and a smaller lower portion, that is, the diameter of the cyclonic exhaust pipe 54 gradually contracts from the upper portion to the lower portion. The cyclonic exhaust pipe 54 operates based on a centrifugal separation mechanism. When hot air tail gas containing large-particle dust enters the cyclonic dust removal chamber 5, under the action of a rotational force, the large-particle dust is thrown toward an inner wall of the cyclonic exhaust pipe 54. The dust settles and accumulates along the gradually contracting inner wall to the bottom of the cyclonic exhaust pipe 54. The dust falls into the ash storage bucket 53 through the dust settling hole 102. The hot air tail gas with large particles removed is conveyed to the spray chamber 6 through the third connecting gas pipe 56 under the action of the induced draft fan 55, and the hot air tail gas then undergoes the next stage of purification in the spray chamber 6.

In some embodiments, to prevent the induced draft fan 55 from reversely sucking dust that has settled in the ash storage bucket 53 into the cyclonic dust removal chamber 5 during air suction by the induced draft fan 55, which may cause secondary pollution of the dust, the dust baffle plate 103 is disposed above the dust settling hole 102. The dust baffle plate 103 blocks interference from the induced draft fan 55 on the dust in the ash storage bucket 53 during air suction by the induced draft fan 55, thereby ensuring that the settled dust remains stably in the ash storage bucket 53.

In some embodiments, the cyclonic exhaust pipe 54 has a structure with a larger upper portion and a smaller lower portion, which enhances the centrifugal separation effect, makes large-particle dust more likely to settle along the contracting inner wall to the bottom, and significantly improves dust removal efficiency. The dust baffle plate 103 effectively blocks the reverse suction force of the induced draft fan 55 on the dust in the ash storage bucket during air suction by the induced draft fan 55, avoids secondary pollution of the dust, and ensures sufficient dust removal.

In some embodiments, a water storage chamber 58 is disposed at an upper portion of the spray chamber 6; a plurality of spray nozzles 57 are disposed below the water storage chamber 58; and a lower portion of the spray chamber 6 is connected to a slurry storage tank 59.

The water storage chamber 58 is a chamber for storing clean water. The slurry storage tank 59 is a storage tank for storing sewage.

In some embodiments, when the spray chamber 6 performs secondary purification of the hot air tail gas, the plurality of spray nozzles 57 are opened. The plurality of spray nozzles 57 sprays water mist into the hot air tail gas. The water mist fully mixes and contacts the hot air tail gas, removing medium-sized particles, aerosols, and acidic gases (e.g., NOx, SO₂, and HCl) from the hot air tail gas. The mixed water mist falls to the bottom of the spray chamber 6 and accumulates into sewage. The sewage is temporarily stored in the slurry storage tank 59.

In some embodiments, the water storage chamber 58 may store clean water. The water storage chamber 58 may also receive an addition of an agent, e.g., disinfectant, flocculant, or the like. A type and a dosage of the agent may be determined based on actual needs.

In some embodiments, an agent is added to the water in the water storage chamber 58. The agent is a mixture of aluminum hydroxide, activated carbon, and ceramic powder, with a mixing mass ratio of 1:(0.12-0.35):(0.15-0.28) and a dosage of 200-1500 g/m³. The activated carbon is coal-based activated carbon with a particle size of 0.1-1.0 mm. The ceramic powder is prepared from fly ash ceramsite with a particle size of 0.05-0.5 mm.

In some embodiments, the agent comprises 1 part of aluminum hydroxide, 0.12-0.35 parts of activated carbon, and 0.15-0.28 parts of ceramic powder.

In some embodiments, the agent comprises 1 part of aluminum hydroxide, the activated carbon may be one of 0.12 parts, 0.18 parts, 0.25 parts, 0.30 parts, or 0.35 parts, and the ceramic powder may be one of 0.15 parts, 0.18 parts, 0.22 parts, 0.25 parts, or 0.28 parts.

In some embodiments, the agent comprises 1 part of aluminum hydroxide, the activated carbon may be in a range of 0.12-0.20 parts, 0.18-0.28 parts, 0.25-0.35 parts, 0.12-0.25 parts, and 0.18-0.35 parts, and the ceramic powder may be in a range of 0.15-0.20 parts, 0.18-0.25 parts, 0.22-0.28 parts, 0.15-0.22 parts, or 0.18-0.28 parts.

In some embodiments, the dosage of the agent may also be one of 200 g/m³, 500 g/m³, 800 g/m³, 1200 g/m³, or 1500 g/m³.

In some embodiments, the dosage of the agent may also be in a range of 200-600 g/m³, 500-1000 g/m³, 800-1500 g/m³, 200-1000 g/m³, or 500-1500 g/m³.

In some embodiments, the particle size of the activated carbon may also be one of 0.1 mm, 0.3 mm, 0.5 mm, 0.7 mm, or 1.0 mm. The particle size of the ceramic powder may also be one of 0.05 mm, 0.15 mm, 0.25 mm, 0.4 mm, or 0.5 mm.

In some embodiments, the particle size of the activated carbon may also be in a range of 0.1-0.4 mm, 0.3-0.7 mm, 0.5-1.0 mm, 0.1-0.6 mm, or 0.4-1.0 mm. The particle size of the ceramic powder may also be in a range of 0.05-0.25 mm, 0.15-0.4 mm, 0.25-0.5 mm, 0.05-0.4 mm, or 0.25-0.5 mm.

In some embodiments, the spray chamber 6 has a structural design with a plurality of spray nozzles, which enables the spray liquid to uniformly cover the gas flow area, expands the contact area, and effectively removes dust and pollutants from the gas. By adding agents to the water storage chamber 58, activated carbon and ceramic powder are utilized to enhance the purification effect.

In some embodiments, two purification assemblies are disposed in the water bath purification chamber 8. Each purification assembly includes a plurality of filter balancing plates 67 arranged at intervals. A first slag discharge pipe 62 and a second slag discharge pipe 63 are respectively disposed for the two purification assemblies. A slag discharge hopper 64 is disposed below each of the two purification assemblies. A slag discharge port 65 is disposed below the slag discharge hopper 64. The slag discharge port 65 is located in a collection bucket 66. The slag discharge port 65 is closed during operation and opened during slag discharge.

The filter balancing plates 67 are filter plates that slow down gas flow velocity, which are spaced apart in the purification assembly, enabling gas entering the water bath to be evenly distributed in water, prolonging gas-liquid contact time, and enhancing the adsorption and dissolution effect of water on particulate matter and soluble pollutants.

In some embodiments, the water bath purification chamber 8 includes the two purification assemblies connected in series, indicating that the hot air tail gas needs to undergo water-bath purification twice. A water-bath purification process includes: the hot air tail gas entering the water in the water bath purification chamber 8 and dispersing into bubbles; the bubbles fully contacting the water of the first set of purification assemblies; pollutants in the bubbles transferring to the water; and the spaced filter balancing plates 67 causing the bubbles to form a multi-layer distribution in the water, prolonging the gas-liquid contact time with the water, intercepting suspended impurity particles in the water, and preventing the suspended impurity particles from escaping with the gas flow. The bubbles float layer by layer to the water surface of the first set of purification assemblies. The bubbles are then sucked into the bottom of a second set of purification assemblies. The water-bath purification process described above is repeated. Gas purified by the two purification assemblies is discharged from an upper portion of the water bath purification chamber 8 to the exhaust pipe 68.

In some embodiments, the spaced filter balancing plates 67 have an angle with respect to the horizontal plane. A higher side of each filter balancing plate 67 is connected to the first slag discharge pipe 62 and the second slag discharge pipe 63. When the filter balancing plates 67 intercept suspended impurities, the suspended impurities float along the inclined filter balancing plates 67 and gather at the slag discharge pipes. The first slag discharge pipe 62 and the second slag discharge pipe 63 suction away the suspended impurity particles. Deposited impurities gather at the slag discharge hopper 64 below the two purification assemblies. The slag discharge port 65 below the slag discharge hopper 64 is closed during operation. The slag discharge port 65 is opened during slag discharge. The slag discharge port 65 discharges the deposited impurities into the collection bucket 66, so as to facilitate subsequent harmless treatment of the impurities.

In some embodiments, by arranging the two purification assemblies connected in series, the hot air tail gas can be subjected to a plurality of water-bath purifications, thereby improving the purification effect. By using the slag discharge pipe to collect floating impurities in the water and using the slag discharge port to collect deposited impurities in the water, impurities in the water can be removed in time to prevent the impurities from escaping with the air flow.

One end of a third connecting gas pipe 56 is connected to an air outlet of a cyclonic exhaust pipe 54, and the other end of the third connecting gas pipe 56 is connected to an air inlet of a spray chamber 6. One end of a fourth connecting gas pipe 60 is connected to an air outlet of the spray chamber 6, and the other end of the fourth connecting gas pipe 60 is connected to an air inlet of an electrostatic dust removal chamber 7. One end of a fifth connecting gas pipe 61 is connected to a top air outlet of the electrostatic dust removal chamber 7, and the other end of the fifth connecting gas pipe 61 is connected to an air inlet of a water bath purification chamber 8. The third connecting gas pipe 56, the fourth connecting gas pipe 60, and the fifth connecting gas pipe 61 connect the cyclonic dust removal chamber 5, the spray chamber 6, the electrostatic dust removal chamber 7, and the water bath purification chamber 8 in series to form a multi-stage purification structure.

In some embodiments, the water bath purification chamber 8 is connected to an exhaust pipe 68, and the exhaust pipe 68 is connected to the high-temperature cracking chamber 2 through a tail gas recovery pipe 70.

The exhaust pipe 68 is a pipeline for discharging the hot air tail gas after multi-stage purification. The exhaust pipe 68 divides the hot air tail gas after multi-stage purification into two parts. One part of the hot air tail gas is discharged to the atmosphere, and the other part of the hot air tail gas enters the high-temperature cracking chamber 2 through the tail gas recovery pipe 70 equipped with an airflow control valve 30 for cyclic cracking.

The tail gas recovery pipe 70 is a tail gas circulation pipeline connecting the exhaust pipe 68 and the high-temperature cracking chamber 2. Since the hot air tail gas purified by the water bath purification chamber 8 contains residual combustible components, in order to further improve utilization, the tail gas recovery pipe 70 recovers a portion of the hot air tail gas from the exhaust pipe 68 to the high-temperature cracking chamber 2 as an auxiliary fuel for cyclic cracking.

The condenser tube 87 is a pipeline for heat exchange inside the biomass gas treatment chamber 9. The condenser tube 87 cools the hot air tail gas mixed with pyrolysis gas, through heat exchange between circulating water inside the condenser tube 87 and the hot air tail gas outside the condenser tube 87, while recovering waste heat from the hot air tail gas.

In some embodiments, in order to improve heat exchange efficiency, the overall contact area between the condenser tubes 87 and the hot air tail gas is increased, a plurality of condenser tubes 87 are in a transverse arrangement, each set of condenser tubes adopt a repeatedly bent structure similar to a serpentine path, and the plurality of sets of condenser tubes 87 are arranged in parallel.

The gas inlet 88 is an inlet interface of the condenser tube 87, and a gas passage port 92 is an outlet interface of the condenser tube 87.

The drying chamber 94 is a chamber for drying the cooled hot air tail gas. The drying chamber 94 may perform drying through methods such as activated carbon adsorption, silica gel adsorption, or molecular sieve adsorption. The drying chamber 94 receives the hot air tail gas through the gas passage port 92, and outputs the dried hot air tail gas through a second gas outlet 95.

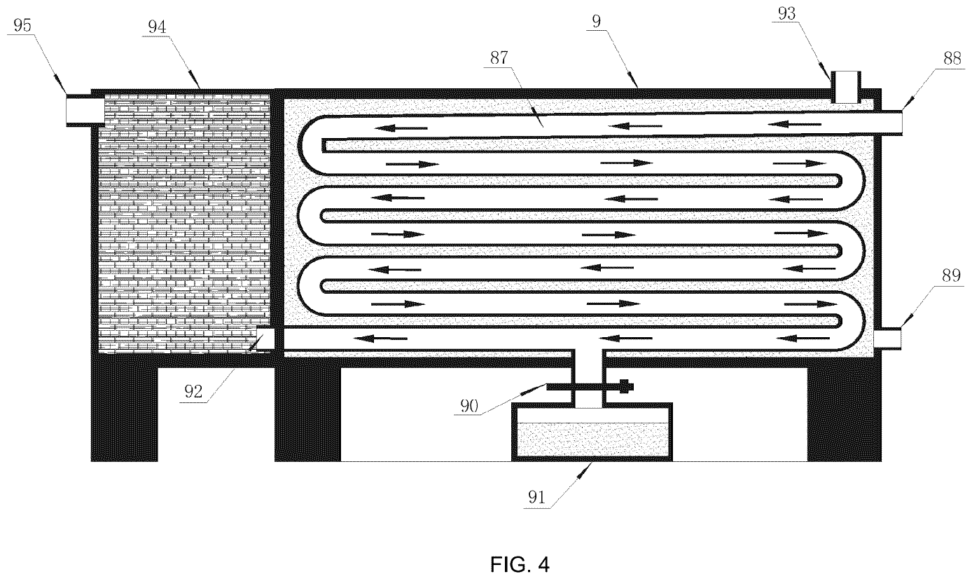

FIG. 4 is a schematic diagram illustrating a vertical cross-sectional structure of a biomass gas treatment chamber according to some embodiments of the present disclosure.

The water inlet 89 is a water inlet interface of the biomass gas treatment chamber 9, which inputs low-temperature circulating water into the condenser tube 87. The water outlet 93 is a water outlet interface of the biomass gas treatment chamber 9, which discharges high-temperature circulating water from the condenser tube 87 after heat exchange is completed.

In some embodiments, the condenser tube 87 is connected to a water tank 91 through a water valve 90. The gas inlet 88 and the gas passage port 92 of the condenser tube 87 are located at the upper part and the lower part of the biomass gas treatment chamber 9, respectively. The second gas outlet 95 is located at the upper part of the drying chamber 94. The water inlet 89 and the water outlet 93 are located at a lower part and a top portion of the biomass gas treatment chamber 9, respectively. The water inlet 89 is connected to a first water storage tank 112 through a third connecting water pipe 113.

The water tank 91 is a storage tank for storing condensed water inside the condenser tube 87. In some embodiments, since the hot air tail gas inside the condenser tube 87 may precipitate condensed water on an inner wall of the condenser tube 87 during a cooling process, and the accumulation of the condensed water inside the condenser tube 87 may cause a decrease in heat exchange efficiency or pipeline blockage, the water tank 91 with a water valve 90 is disposed at the bottom of the condenser tubes 87 to collect condensed water from the inner walls of the condenser tubes 87 into the water tank 91, thereby maintaining the cooling effect of the condenser tubes 87.

The first water storage tank 112 is a storage tank for providing circulating water. In some embodiments, because the heated circulating water enters the steam boiler 4 through the water outlet 93 as a water source for the steam boiler 4, the circulating water inside the biomass gas treatment chamber 9 undergoes loss. The circulating water may be supplemented through the first water storage tank 112.

In some embodiments, by arranging the water tank 91 to collect the condensed water, the inner wall of the condenser tube 87 can be kept dry to ensure the cooling effect. By arranging the first water storage tank 112 to provide the circulating water, a continuous and stable supply of the circulating water can be ensured.

The gas return pipe 86 is a gas transmission pipeline for returning the dried hot air tail gas to the pyrolysis chamber 1, which connects the second gas outlet 95 of the biomass gas treatment chamber 9 and the first biomass air inlet 16 of the pyrolysis chamber 1. The dried hot air tail gas enters the pyrolysis chamber 1 sequentially through the second gas outlet 95, the gas return pipe 86, and the first biomass air inlet 16 for cyclic pyrolysis.

The first hot air inlet pipe 84 is a gas transmission pipeline for delivering the hot air tail gas to the biomass gas treatment chamber 9 for drying. The hot air tail gas inside an air-drying cylinder 41 enters the biomass gas treatment chamber 9 sequentially through a first gas outlet 45, the first hot air inlet pipe 84, and the gas inlet 88 for drying.

The first connecting water pipe 98 is a drain pipe for delivering the high-temperature circulating water to the steam boiler 4. The high-temperature circulating water generated by the biomass gas treatment chamber 9 enters the steam boiler 4 sequentially through the water outlet 93, the first connecting water pipe 98, and a hot water inlet 50, which serves as the water source for the steam boiler 4. Compared to directly using cold water as the water source, using the preheated high-temperature circulating water helps save energy.

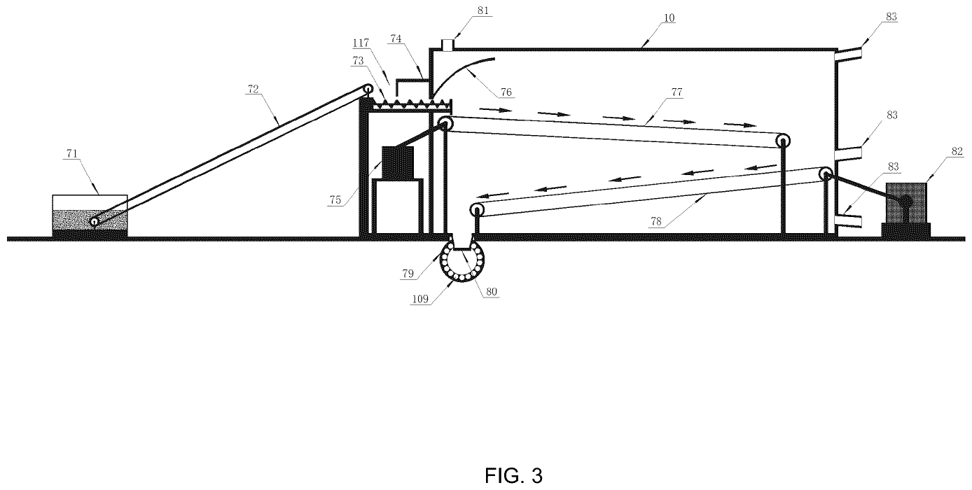

FIG. 3 is a schematic diagram illustrating a vertical cross-sectional structure of a metal carbonization chamber according to some embodiments of the present disclosure.

The hot air inlet 83 introduces hot air as a heat source for metal carbonization, and the pyrolysis gas outlet 81 discharges pyrolysis gas generated by the metal carbonization chamber.

In some embodiments, a portion of the hot air tail gas located outside the air-drying cylinder 41 enters the metal carbonization chamber 10, sequentially through a hot air outlet 49, a second hot air inlet pipe 107, and the hot air inlet 83. The high-temperature hot air tail gas heats metal-containing waste inside the metal carbonization chamber 10. The pyrolysis gas generated by the metal-containing waste and the cooled hot air tail gas enter the high-temperature cracking chamber 2 sequentially through the pyrolysis gas outlet 81, a gas outlet pipe 85, and a second biomass air inlet 37 for cyclic cracking. By arranging the above-mentioned circulation pipelines, the pyrolysis gas generated by the metal carbonization chamber 10 is utilized as additional raw material for the high-temperature cracking chamber 2, thereby improving heat production efficiency of the integrated device.

In some embodiments, a metal carbonization chamber feed inlet 117 is disposed on a side of the metal carbonization chamber 10, a material collecting pit 79 is disposed on a bottom surface of the metal carbonization chamber 10, the material collecting pit 79 has a tubular cross-section, a discharge hopper 80 is disposed on an upper side of the material collecting pit 79, and the discharge hopper 80 is gravity-sensing openable and closable.

The metal carbonization chamber feed inlet 117 is a feeding port for adding metal-containing waste. The material collecting pit 79 is a device for collecting carbonized metal residue.

In some embodiments, when a weight of material inside the discharge hopper 80 exceeds 2 kg, the discharge hopper 80 automatically opens, and closes after discharging the material.

In some embodiments, because the carbonized metal residue is at a high temperature, water is provided inside the material collecting pit 79 to cool the metal residue and prevent the metal residue from reigniting.

In some embodiments, a water level inside the material collecting pit 79 is 40%-60% of the depth of the material collecting pit 79.

In some embodiments, the water level inside the material collecting pit 79 may also be one of 40%, 45%, 50%, 55%, or 60% of the depth of the material collecting pit 79.

In some embodiments, the water level inside the material collecting pit 79 may also be in a range of 40%-55%, 45%-60%, 40%-50%, 45%-55%, or 50%-60% of the depth of the material collecting pit 79.

In some embodiments, the material collecting pit 79 is connected to a slag remover 96. An inner side of the material collecting pit 79 is provided with a cooling tube 109. The cooling tube 109 is connected to the steam boiler 4 through a second connecting water pipe 110. A circulation water pump 111 is arranged on the second connecting water pipe 110. The cooling tube 109 is connected to a second water storage tank 114 through a fourth connecting water pipe 115.

The slag remover 96 is configured to perform de-slagging treatment on the carbonized metal residue, so as to separate the residue from metal. The slag remover 96 includes an air separation machine, a vibrating screening machine, or the like.

In some embodiments, for cooling the water in the material collecting pit 79, the circulation water pump 111 draws cooling water from the second water storage tank 114 and supplies the cooling water to the cooling tube 109 through the fourth connecting water pipe 115. The cooling water cools the material collecting pit 79. The heated cooling water enters the steam boiler 4 through the second connecting water pipe 110 and serves as a water source for the steam boiler 4.

In some embodiments, an upper mesh belt conveyor 77 and a lower mesh belt conveyor 78 are disposed in the metal carbonization chamber 10. The upper mesh belt conveyor 77 is disposed above the lower mesh belt conveyor 78. One end of the upper mesh belt conveyor 77 is disposed at the metal carbonization chamber feed inlet 117. One end of the lower mesh belt conveyor 78 is disposed near the material collecting pit 79. The upper mesh belt conveyor 77 is connected to the first speed reducer 75. The lower mesh belt conveyor 78 is connected to the second speed reducer 82.

In some embodiments, as shown in FIG. 3, the upper mesh belt conveyor 77 and the lower mesh belt conveyor 78 are arranged side by side in an up-down direction. A conveying direction of the upper mesh belt conveyor 77 is opposite to a conveying direction of the lower mesh belt conveyor 78. After the metal-containing waste is added through the metal carbonization chamber feed inlet 117, the metal-containing waste first falls onto the upper mesh belt conveyor 77 for carbonization. The metal-containing waste is gradually conveyed with the upper mesh belt conveyor 77 until the metal-containing waste falls onto the lower mesh belt conveyor 78. The metal-containing waste is gradually conveyed with the lower mesh belt conveyor 78 until the metal-containing waste falls into the material collecting pit 79.

In some embodiments, a plurality of metal carbonization chambers 10 may be employed. The plurality of metal carbonization chambers 10 may be connected in parallel, thereby enabling simultaneous carbonization of a plurality of batches of metal-containing waste and improving carbonization efficiency.

In some embodiments, water is disposed in the material collecting pit 79. The water can be utilized to promptly cool and lower a temperature of carbonized metal residues, thus secondary combustion of the metal residues in contact with air at high temperatures can be avoided, and the safety and environmental friendliness of a metal recovery process can be ensured.

In some embodiments, the hot air inlets 83 are arranged along a vertical height direction of the metal carbonization chamber 10 in three rows: an upper row, a middle row, and a lower row. The distance between adjacent hot air inlets 83 in each row is in a range of 0.4 m-1.2 m. The distance between the upper row and the lower row is in a range of 0.5 m-1.5 m.

In some embodiments, the distance between adjacent hot air inlets 83 in each row may alternatively be one of 0.4 m, 0.5 m, 0.6 m, 0.7 m, 0.8 m, 0.9 m, 1.0 m, 1.1 m, or 1.2 m. The distance between the upper row and the lower row may alternatively be one of 0.5 m, 0.6 m, 0.7 m, 0.8 m, 0.9 m, 1.0 m, 1.1 m, 1.2 m, 1.3 m, 1.4 m, or 1.5 m.

In some embodiments, the distance between adjacent hot air inlets 83 in each row may alternatively be in a range of 0.4 m-0.6 m, 0.6 m-0.8 m, 0.8 m-1.0 m, 1.0 m-1.2 m, 0.4 m-0.8 m, 0.8 m-1.2 m, 0.5 m-1.0 m, or 0.5 m-1.2 m. The distance between the upper row and the lower row may alternatively be in a range of 0.5 m-0.7 m, 0.7 m-0.9 m, 0.9 m-1.1 m, 1.1 m-1.3 m, 1.3 m-1.5 m, 0.5 m-0.9 m, 0.9 m-1.3 m, 1.1 m-1.5 m, 0.6 m-1.0 m, 0.8 m-1.2 m, 1.0 m-1.4 m, 0.7 m-1.2 m, or 0.9 m-1.4 m.

In some embodiments, hot air inlets 83 located in the upper row have a downward inclination angle of 8°-30°, hot air inlets 83 located in the middle row have a downward inclination angle of 1°-15°, and hot air inlets 83 located in the lower row have an upward inclination angle of 3°-20°.

In some embodiments, the downward inclination angle of the hot air inlet 83 in the upper row may alternatively be one of 8°, 10°, 12°, 14°, 16°, 18°, 20°, 22°, 24°, 26°, 28°, or 30°. The downward inclination angle of the hot air inlet 83 in the middle row may alternatively be one of 1°, 3°, 5°, 7°, 9°, 11°, 13°, or 15°. The upward inclination angle of the hot air inlet 83 in the lower row may alternatively be one of 3°, 5°, 8°, 10°, 12°, 15°, 18°, or 20°.

In some embodiments, the downward inclination angle of the hot air inlet 83 in the upper row may alternatively be in a range of 8°-12°, 10°-16°, 14°-20°, 18°-24°, 22°-28°, 26°-30°, 8°-16°, 14°-24°, 20°-30°, 8°-20°, or 16°-30°. The downward inclination angle of the hot air inlet 83 in the middle row may alternatively be in a range of 1°-5°, 3°-9°, 7°-13°, 9°-15°, 1°-9°, 5°-13°, 7°-15°, or 1°-15°. The upward inclination angle of the hot air inlet 83 in the lower row may alternatively be in a range of 3°-8°, 5°-12°, 10°-18°, 15°-20°, 3°-12°, 8°-18°, 12°-20°, 3°-18°, 8°-20°, or 3°-20°.

In some embodiments, the hot air inlets 83 are arranged in three rows (upper, middle, and lower) along the vertical height direction of the metal carbonization chamber 10, thereby ensuring uniform carbonization heating of the vertically arranged upper mesh belt conveyor 77 and lower mesh belt conveyor 78 by hot tail gas, eliminating heating dead zones inside the metal carbonization chamber 10, and avoiding insufficient local carbonization.

In some embodiments, the metal carbonization chamber 10 is connected to a second feeding system 12. The second feeding system 12 includes a second storage bin 71, a second feeder 72, and a screw feeder 73. One end of the second feeder 72 is disposed inside the second storage bin 71, the other end of the second feeder 72 is disposed above the screw feeder 73. The screw feeder 73 is disposed at the metal carbonization chamber feed inlet 117. A dust shield plate 74 is disposed above the screw feeder 73 and connected to the metal carbonization chamber 10. An ash baffle plate 76 is disposed inside the metal carbonization chamber 10 at the metal carbonization chamber feed inlet 117, and the ash baffle plate 76 has an arched structure with a tangent forming an angle of 35°-65° with the horizontal direction.

A function of the second feeding system 12 is similar to a function of the first feeding system 11, whereas the only difference is that the first feeding system 11 is an automated feeding system for adding the organic solid waste to the pyrolysis chamber 1, while the second feeding system 12 is an automated feeding system for adding the metal-containing waste to the metal carbonization chamber 10.

The second storage bin 71 is configured to store the metal-containing waste. The screw feeder 73 is configured to achieve quantitative and stable conveying of the metal-containing waste.

In some embodiments, when the metal carbonization chamber 10 operates, the second feeder 72 conveys the metal-containing waste from the second storage bin 71 to be above the screw feeder 73. The metal-containing waste falls into the screw feeder 73. Under a rotational pushing force of a screw blade, the metal-containing waste is pushed to the metal carbonization chamber feed inlet 117. The metal-containing waste falls onto the upper mesh belt conveyor 77. The metal-containing waste is conveyed with the upper mesh belt conveyor 77 and gradually carbonized. When the metal-containing waste is conveyed to an end of the upper mesh belt conveyor 77, the metal-containing waste falls onto the lower mesh belt conveyor 78. The metal-containing waste is conveyed with the lower mesh belt conveyor 78 and continues to be carbonized. Finally, the carbonized metal residues fall into the material collecting pit 79.

In some embodiments, the dust shield plate 74 is disposed above the screw feeder 73. The dust shield plate 74 is connected to the metal carbonization chamber 10. The ash baffle plate 76 is disposed inside the metal carbonization chamber 10. The ash baffle plate 76 is disposed at the metal carbonization chamber feed inlet 117. The ash baffle plate 76 has an arched structure. The angle between the tangent of the arched structure and the horizontal direction is 35°-65°.

A function of the dust shield plate 74 is similar to a function of the cover plate 106, whereas the only difference is that the cover plate 106 is a sealing structure of the first feeding system 11, while the dust shield plate 74 is a sealing structure of the second feeding system 12. The shape and size of the dust shield plate 74 are adapted to the screw feeder 73.

The ash baffle plate 76 is a dust interception component of the metal carbonization chamber 10. A function and a shape of the ash baffle plate 76 are similar to a function and a shape of the first dust suppression plate 22 and a function and a shape of the second dust suppression plate 36. The ash baffle plate 76, the first dust suppression plate 22, and the second dust suppression plate 36 each have an arched structure. The bottom of the ash baffle plate 76 fits a side wall where the metal carbonization chamber feed inlet 117 is located. An opening is formed between the top of the ash baffle plate 76 and the pyrolysis gas outlet 81 for gas to pass through.

In some embodiments, the angle between the tangent of the arched structure of the ash baffle plate 76 and the horizontal direction may be one of 35°, 40°, 45°, 50°, 55°, 60°, or 65°.

In some embodiments, the angle between the tangent of the arched structure of the ash baffle plate 76 and the horizontal direction may be in a range of one of 35°-45°, 40°-50°, 45°-55°, 50°-60°, 55°-65°, 35°-50°, 45°-65°, or 40°-60°.

In some embodiments, the dust shield plate 74 is closed and sealed with the screw feeder 73, thereby blocking the reverse leakage path of high-temperature airflow from the metal carbonization chamber feed inlet 117 and ensuring stable operation of the screw feeder 73; the ash baffle plate 76 is disposed to reduce powder in gas subsequently entering the high-temperature cracking chamber 2, thus improving dust-lowering efficiency.

In some embodiments, the organic solid waste is added into the pyrolysis chamber 1, wherein the organic solid waste has a water content below 20% and a calorific value higher than 3000 kcal/kg, metal-containing waste is added into the metal carbonization chamber 10, wherein the metal-containing waste has a water content below 15%, and material to be dried in the material drying chamber 3 has a water content below 55% and a particle size of 5 mm-40 mm.

In some embodiments, the water content of the organic solid waste may be one of 0%, 4%, 8%, 12%, 16%, or 20%. The calorific value of the organic solid waste may be one of 3000 kcal/kg, 3400 kcal/kg, 3800 kcal/kg, 4200 kcal/kg, 4600 kcal/kg, or 5000 kcal/kg. The water content of the metal-containing waste may alternatively be one of 0%, 3%, 6%, 9%, 12%, or 15%. The water content of the material to be dried in the material drying chamber 3 may alternatively be one of 20%, 27%, 34%, 41%, 48%, or 55%. The particle size of the material to be dried may alternatively be one of 5 mm, 10 mm, 15 mm, 20 mm, 25 mm, 30 mm, 35 mm, or 40 mm.

In some embodiments, the water content of the organic solid waste may alternatively be in a range of 0%-4%, 4%-8%, 8%-12%, 12%-16%, 16%-20%, 0%-8%, 4%-12%, 8%-16%, or 12%-20%. The calorific value of the organic solid waste may alternatively be in a range of 3000-3400 kcal/kg, 3400-3800 kcal/kg, 3800-4200 kcal/kg, 4200-4600 kcal/kg, 4600-5000 kcal/kg, 3000-3800 kcal/kg, 3400-4200 kcal/kg, 3800-4600 kcal/kg, or 4200-5000 kcal/kg. The water content of the metal-containing waste may alternatively be in a range of 0%-3%, 3%-6%, 6%-9%, 9%-12%, 12%-15%, 0%-6%, 3%-9%, 6%-12%, or 9%-15%. The water content of the material to be dried in the material drying chamber 3 may alternatively be in a range of 20%-27%, 27%-34%, 34%-41%, 41%-48%, 48%-55%, 20%-34%, 27%-41%, 34%-48%, or 41%-55%. The particle size of the material to be dried may alternatively be in a range of 5-15 mm, 10-20 mm, 15-25 mm, 20-30 mm, 25-35 mm, 30-40 mm, 5-20 mm, 10-25 mm, 15-30 mm, 20-35 mm, 25-40 mm, or 5-25 mm.

In some embodiments, by setting the water content of the organic solid waste, metal-containing waste, and material to be dried, the metal recovery efficiency of the metal-containing waste and the pyrolysis efficiency of the organic solid waste are ensured.

In some embodiments, each of the pyrolysis chamber 1, the high-temperature cracking chamber 2, the material drying chamber 3, the biomass gas treatment chamber 9, and the metal carbonization chamber 10 are provided with 4-8 temperature monitoring points 38 and 2-4 pressure monitoring points 97; the steam boiler 4 is provided with 2-4 temperature monitoring points 38 and 2 pressure monitoring points 97, the second connecting gas pipe 52 is provided with 2-4 temperature monitoring points 38, the exhaust pipe 68 is provided with 2-4 temperature monitoring points 38, and the lower hot air pipe 39 is provided with 2 temperature monitoring points 38.

The temperature monitoring point 38 is a sampling point for monitoring temperature data. The pressure monitoring point 97 is a sampling point for monitoring pressure data. In some embodiments, the thermometer is installed at the temperature monitoring point 38. The pressure gauge is installed at the pressure monitoring point 97.

In some embodiments, the integrated device may regulate operation of the integrated device based on the temperature data and the pressure data. For example, when the temperature monitoring point 38 and the pressure monitoring point 97 on the steam boiler 4 detect abnormal data of high temperature and high pressure, the airflow control valve 30 on the steam outlet 51 is emergently opened. Part of the steam is released from the steam outlet 51. Safe and stable operation of the steam boiler 4 is ensured.

In some embodiments, the temperature monitoring points 38 and the pressure monitoring points 97 are disposed on a plurality of chambers of the integrated device. This arrangement helps monitor the operational status of the integrated device in real time. When an abnormality occurs in the integrated device, emergency regulation is performed, ensuring the safe and stable operation of the integrated device.

In some embodiments, the exhaust pipe 68 is provided with a monitoring box 69, wherein the monitoring box 69 is provided with probes for a variety of monitoring gases.

The monitoring box 69 is a monitoring module for monitoring the gas composition in the exhaust pipe 68. The monitoring box 69 may include probes for monitoring dioxins, nitrogen oxides (NOx, SO₂), HCl, CO, total volatile organic compounds, particulate matter, heavy metals, etc. A sampling period of the monitoring box 69 may be determined based on actual needs. For example, data is collected once every 30-120 min.

In some embodiments, the integrated device may regulate the operation of the integrated device based on gas data collected by the monitoring box 69. For example, when the monitoring box 69 detects that the dioxin concentration in the exhaust pipe 68 is too high, the count of combustion accelerator added to the high-temperature cracking chamber 2 is increased and the cracking temperature is raised, thereby enhancing the high-temperature decomposition effect on dioxins, and ensuring that the discharged tail gas meets environmental protection requirements.

In some embodiments, the monitoring box 69 is disposed on the exhaust pipe 68, which helps monitor the concentrations of various pollutants in tail gas in real time. When a concentration becomes abnormal, emergency regulation is performed to ensure that the discharged tail gas meets environmental protection standards.

A method for using an integrated device for drying organic solid waste and extracting metals according to an embodiment of the present disclosure includes: adding the organic solid waste into the pyrolysis chamber 1 for pyrolysis, a generated pyrolysis gas entering the high-temperature cracking chamber 2 through the air passage port 26 for cracking treatment, hot air generated by cracking entering into the material drying chamber 3 through the lower hot air pipe 39 to heat an outer side of the air-drying cylinder 41, and hot air generated by cracking through the upper hot air pipe 40 heating and drying a material to be dried inside the air-drying cylinder 41, a portion of the hot air on the outer side of the air-drying cylinder 41 entering the metal carbonization chamber 10 through the hot air outlet 49, the other portion of the hot air on the outer side of the air-drying cylinder 41 entering the steam boiler 4 through the first connecting gas pipe 48, and the metal carbonization chamber 10 carbonizing and recovering added metal-containing waste, a generated gas entering the high-temperature cracking chamber 2 sequentially through the pyrolysis gas outlet 81, the gas outlet pipe 85, and the second biomass air inlet 37; the hot air in the air-drying cylinder 41 entering the biomass gas treatment chamber 9 sequentially through the first gas outlet 45, the first hot air inlet pipe 84, and the gas inlet 88, after the hot air is dehydrated in the biomass gas treatment chamber 9, the hot air entering the pyrolysis chamber 1 sequentially through the second gas outlet 95, the gas return pipe 86, and the first biomass air inlet 16 to be pyrolyzed; the hot air entering the steam boiler 4 being heat-absorbed and then, under action of the induced draft fan 55, being treated sequentially through the cyclonic dust removal chamber 5, the spray chamber 6, the electrostatic dust removal chamber 7, and the water bath purification chamber 8; and a portion of gas purified by the water bath purification chamber 8 entering the high-temperature cracking chamber 2 through the tail gas recovery pipe 70, and the other portion being discharged externally through the exhaust pipe 68.

In some embodiments, the integrated device can realize the integrated treatment of organic solid waste and metal recovery, combine the drying of organic solid waste with the efficient utilization of tail gas from metal recovery, reduce the tail gas treatment cost, and achieve the high resource utilization of organic waste. Due to the lack of an absolutely oxygen-free environment, the existing metal recovery methods have a high metal oxidation loss rate at high temperatures; meanwhile, the use of nitrogen and inert gases leads to an increase in metal recovery costs. In traditional methods, the carbonization materials are placed on the grate in the carbonization chamber, and the carbonization efficiency is low due to the surface heat exchange of hot air, resulting in low content of combustible gases generated during the pyrolysis process of the equipment and great difficulty in utilizing the combustible gases. In addition, the large temperature fluctuation range of the carbonization chamber in traditional equipment leads to incomplete or excessive carbonization of metal-containing organic waste, resulting in low metal recovery rate, low utilization rate of organic components in the metal-containing organic waste, and low operation efficiency. The present disclosure realizes the dehydration and reuse of gases generated from the drying organic waste, achieves the heat energy recovery of drying gases and the reuse of tail gas, and fundamentally improves energy efficiency and reduces environmental pollution.

The integrated device of the present disclosure realizes the high-temperature cracking treatment of biomass gas generated from the pyrolysis of metal-containing waste and organic waste gas generated from the drying of organic waste, achieves maximum energy utilization, and reduces the cost of tail gas treatment. The present disclosure effectively utilizes tail gas after high-temperature cracking and reduces the cost of metal waste treatment. The integrated device of the present disclosure realizes multi-stage full cracking through efficient heat preservation, combustion improver addition, and a special structural system, so that dioxins are fully decomposed; meanwhile, through special additives, the re-synthesis of dioxins is reduced, and the cost of tail gas purification is low. Through the special structural design of the metal carbonization chamber 10, part of the hot air can penetrate the metal-containing organic waste; at the same time, after the hot air radiates heat on the surface of the metal-containing organic waste, it is reflected multiple times, realizing the rapid generation of a large amount of combustible gas, more thorough carbonization and higher carbonization efficiency. The integrated device of the present disclosure not only improves the thermal energy utilization efficiency of organic solid waste and the metal recovery rate, but also significantly reduces the amount of waste gas generated, which has important practical significance for promoting the high-value utilization of organic solid waste and the development of the metal recovery industry.

In some embodiments, the temperature of the pyrolysis chamber 1 is in a range of 350-600° C. The temperature of the high-temperature cracking chamber 2 is in a range of 850-1000° C. When the metal carbonization chamber 10 recovers metal from the organic solid waste, the temperature of the metal carbonization chamber 10 is in a range of 350-600° C.; and when the metal carbonization chamber 10 recovers metal from a mineral, a temperature of the metal carbonization chamber 10 is in a range of 600-950° C.

In some embodiments, the temperature of the pyrolysis chamber 1 may also be one of 350° C., 400° C., 450° C., 500° C., 550° C., and 600° C. The temperature of the high-temperature cracking chamber 2 may also be one of 850° C., 900° C., 950° C., or 1000° C. When the metal carbonization chamber 10 recovers metals from organic solid waste, the temperature may also be one of 350° C., 400° C., 450° C., 500° C., 550° C., or 600° C. When the metal carbonization chamber 10 recovers metals from the mineral, the temperature may also be one of 600° C., 700° C., 800° C., 900° C., or 950° C.

In some embodiments, the temperature of the pyrolysis chamber 1 may also be in a range of 350-450° C., 400-500° C., 450-600° C., 350-500° C., 400-600° C., 350-550° C., 450-550° C., or 500-600° C. The temperature of the high-temperature cracking chamber 2 may also be in a range of 850-950° C., 900-1000° C., 850-900° C., 950-1000° C., or 900-950° C. When the metal carbonization chamber 10 recovers metals from organic solid waste, the temperature may also be in a range of 350-450° C., 400-500° C., 450-600° C., 350-500° C., 400-600° C., 350-550° C., 450-550° C., or 500-600° C. When the metal carbonization chamber 10 recovers metals from the mineral, the temperature may also be in a range of 600-750° C., 700-850° C., 800-950° C., 600-800° C., 750-950° C., 600-900° C., or 700-950° C.

In some embodiments, the temperature of the pyrolysis chamber 1 may be controlled by controlling a feeding amount and an amount of fuel gas entering from the biomass gas treatment chamber 9.

In some embodiments, the temperature of the high-temperature cracking chamber 2 may be controlled, by controlling an air intake amount of the second biomass air inlet 37 of the metal carbonization chamber 10, an amount of biomass additive added through the combustion accelerator inlet 27, and an amount of mixed gas returned through the self-circulation inlet 100.

In some embodiments, a residence time of gas entering the pyrolysis chamber 1 and the high-temperature cracking chamber 2 is in a range of 3-8 s.

In some embodiments, after the pyrolysis chamber 1 and the high-temperature cracking chamber 2 meet normal operating temperature conditions, the metal carbonization chamber 10 is started. After the metal carbonization chamber 10 operates normally and an operating load reaches more than 70% of a designed load, the first feeding system 11 stops feeding. A push plate 105 and a cover plate 106 at the front end of the material pushing system 17 are closed to seal. When the high-temperature cracking chamber 2 is below 850° C., the first feeding system 11 starts to feed organic solid waste onto a grate 20 in the pyrolysis chamber 1.

In some embodiments, when the metal carbonization chamber 10 recovers metals from organic solid waste, a lower carbonization temperature can inhibit metal oxidation loss. When the metal carbonization chamber 10 recovers metals from minerals, a higher carbonization temperature can promote phase separation and improve yield.

Taking drying organic solid waste and recovering metal-containing waste as examples, the following further describes the integrated device and the use method thereof provided by some embodiments of the present disclosure.

### Example 1

Referring to FIG. 1-FIG. 4 to illustrate the present embodiment, the integrated device of Example 1 achieves drying of organic solid waste such as sludge, Chinese medicine residues, and livestock and poultry manure, thereby achieving recovery and utilization of metal-containing waste, such as metal zippers and various aluminum-containing plastic wastes. The integrated device achieves a drying operating load of 0.5-5.0 tons/hour, achieves a metal recovery operating load of 1.0-10.0 tons/hour, and achieves ultra-low (near-zero) pollutant emissions. Pollutant emission indicators monitored for the tail gas are shown in Table 1. NOx and HCl are both below detection limits and monitored indicator values of NOx and HCl are zero. Other indicators are significantly lower than national standard limits, achieving near-zero emissions domestically.

The integrated device provided by the present disclosure achieves a thermal energy conversion rate of organic solid waste greater than 90%, a metal extraction rate from organic solid waste exceeding 90%, a metal extraction rate from mineral powder exceeding 80%, a reduction in tail gas generation by more than 50%, a reduction in tail gas treatment cost by more than 70%, and an improvement in carbonization efficiency by more than 50%.

TABLE 1
emission indicators table of the tail gas in Example 1.

| Pollutant | Dioxins | NOₓ | SO₂ | HCl | CO |
|---|---|---|---|---|---|
| item | (ng TEQ/m³) | (mg/m³) | (mg/m³) | (mg/m³) | (mg/m³) |
| Concentration | 0.01 ± 0.003 | 0.000 | 0.859 ± 0.165 | 0.000 | 6.326 ± 1.078 |
| Standard Limit | 0.1 | 250 | 80 | 50 | 80 |

| | | | | | Sb, As, Pb, |
|---|---|---|---|---|---|
| | | | | Total | Cr, Co, Cu, |
| | | Hg and | Cd, Tl, and | volatile | Mn, Ni, and |
| | Particulate | related | related | organic | related |
| Pollutant | matter | compounds | compounds | compounds | compounds |
| item | (mg/m³) | (mg/m³) | (mg/m³) | (mg/m³) | (mg/m³) |
| Concentration | 3.152 ± 0.527 | (2.15 ± 0.42) × | (8.59 ± 1.77) × | 2.523 ± 0.798 | 0.076 ± 0.023 |
| | | 10⁻⁴ | 10⁻³ | | |
| Standard Limit | 20 | 0.05 | 0.1 | 60 | 1.0 |

It should be noted that the standard limit for total volatile organic compounds is adopted from the “Emission Control Standard for Volatile Organic Compounds of Industrial Enterprises” (DB12/524-2020). Other indicators in the table are adopted from the “Standard for Pollution Control on the Municipal Solid Waste Incineration” (GB18485-2014).

### Example 2

This example takes the drying of municipal sludge and the extraction of aluminum from aluminum-containing waste plastics as an illustration.

In Example 2, an ash cleaning interval of the ash cleaning fan 32 is 6 h. A spray agent of the spray chamber 6 is a mixture of aluminum hydroxide, activated carbon, and ceramic powder, with a mixing ratio of 1:0.12:0.15 and a dosage of 200 g/m³. A data acquisition interval of the monitoring box 69 is 30 minutes. A ratio of the air volume from tail gas to the air volume from the high-temperature cracking chamber 2 for the secondary air fan 29 is 1:0.1. A flow rate of the primary air fan 23 is 2000 m³/(ton·hour). The water level in the material collecting pit 79 is 40% of the depth of the material collecting pit 79. The water level in the slag storage tank 25 is 30% of the depth of the slag storage tank 25. The distance between adjacent hot air inlets 83 in each of the upper, middle, and lower rows is 0.4 m. The distance between the upper row and the lower row of the hot air inlets 83 is 0.5 m. The inclination angles of the hot air inlets 83 in the upper row, the middle row, and the lower row are 8° downward, 1° downward, and 3° upward, respectively. The angles between tangents of the first dust suppression plate 22, the second dust suppression plate 36, and the ash baffle plate 76 and the horizontal direction are 55°, 65°, and 35°, respectively. The biomass additive for the combustion accelerator inlet 27 is wood charcoal. The additive is a mixture of modified woody biochar, fiberglass reinforced plastic powder, calcium sulfate, diatomite, ceramic powder, and activated carbon, with a mixing ratio of 1:0.03:0.01:0.03:0.1:0.12. The modified woody biochar in the additive is a mixture of ferric chloride-modified biochar and NaOH-modified biochar with a mixing ratio of 1:0.5. The concentration of the ferric chloride modifier is 0.01 mol/L. The concentration of the NaOH modifier is 0.01 mol/L. The modification time is 24 h.

In Example 2, the pyrolysis chamber 1, the high-temperature cracking chamber 2, the material drying chamber 3, the biomass gas treatment chamber 9, and the metal carbonization chamber 10 are each provided with 4 temperature points and 2 pressure points. The steam boiler 4 is provided with 2 temperature points and 2 pressure points. The second connecting gas pipe 52 and the exhaust pipe 68 are each provided with 2 temperature points. The lower hot air pipe 39 is provided with 2 temperature points.

In Example 2, the organic solid waste in the pyrolysis chamber 1 is dried municipal sludge. The metal-containing waste in the metal carbonization chamber 10 is aluminum-containing plastic. The material to be dried in the material drying chamber 3 is sludge. The temperature of the metal carbonization chamber 10 is in a range of 350° C.-600° C.

In Example 2, the water content of the municipal sludge after dehydration, impurity removal, and drying is in a range of 10.2%-15.6%, and the calorific value of the municipal sludge is in a range of 3000 kcal/kg-4000 kcal/kg. The water content of the aluminum-containing plastic is in a range of 3.6%-10.7%. The water content of the sludge to be dried in the material drying chamber 3 is in a range of 40.9%-55.0%, and the particle size of the sludge to be dried is in a range of 5 mm-40 mm.

In Example 2, the operating load of the device of the pyrolysis chamber 1 is 1.0 m³/h. The volume inside the high-temperature cracking chamber 2 is 10 m³. Volumes of other devices match the pyrolysis chamber 1 and the high-temperature cracking chamber 2. Experimental results show that the thermal energy conversion rate of the organic solid waste is as high as 90.5%-95.3%, the metal extraction rate is in a range of 92.6%-97.9%, the tail gas generation of the integrated device is reduced by 55.1%-68.5%, the tail gas treatment cost is reduced by 75.4%-79.5%, the carbonization efficiency is improved by 55.9%-61.3%, the operating efficiency is significantly improved, ultra-low pollution emission is achieved.

The integrated device achieves drying of municipal sludge, and achieves recycling and utilization of metal from aluminum-containing plastics. The integrated device achieves an operating load of 1.0 ton/hour for drying municipal sludge, achieves an operating load of 2.0 ton/hour for metal recovery, thereby achieving near-zero emission of pollutants. Pollutant emission indicators monitored from tail gas are shown in Table 2. NOx and HCl are both below a detection limit, and monitored indicator values are zero. Other indicators are significantly lower than national standard limits.

TABLE 2
emission indicators table of the tail gas in Example 2.

| Pollutant | Dioxins | NOₓ | SO₂ | HCl | CO |
|---|---|---|---|---|---|
| item | (ng TEQ/m³) | (mg/m³) | (mg/m³) | (mg/m³) | (mg/m³) |
| Concentration | 0.008 ± 0.002 | 0.000 | 0.725 ± 0.112 | 0.000 | 3.694 ± 0.826 |
| Standard Limit | 0.1 | 250 | 80 | 50 | 80 |

| | | | | | Sb, As, Pb, |
|---|---|---|---|---|---|
| | | | | Total | Cr, Co, Cu, |
| | | Hg and | Cd, Tl, and | volatile | Mn, Ni, and |
| | Particulate | related | related | organic | related |
| Pollutant | matter | compounds | compounds | compounds | compounds |
| item | (mg/m³) | (mg/m³) | (mg/m³) | (mg/m³) | (mg/m³) |
| Concentration | 2.571 ± 0.319 | (1.32 ± 0.19) × | (6.22 ± 0.82) × | 2.327 ± 0.519 | 0.042 ± 0.011 |
| | | 10⁻⁴ | 10⁻³ | | |
| Standard limit | 20 | 0.05 | 0.1 | 60 | 1.0 |

It should be noted that the standard limit for total volatile organic compounds is adopted from the “Emission Control Standard for Volatile Organic Compounds of Industrial Enterprises” (DB12/524-2020). Other indicators in the table are adopted from the “Standard for Pollution Control on the Municipal Solid Waste Incineration” (GB18485-2014).

### Example 3

This example takes the drying of Chinese medicine residues and metal extraction from fabric zippers as an illustration.

In Example 3, the ash cleaning interval of the ash cleaning fan 32 is 12 h. The spray agent of the spray chamber 6 is a mixture of aluminum hydroxide, activated carbon, and ceramic powder, with a mixing ratio of 1:0.35:0.28 and a dosage of 1500 g/m³. The data acquisition interval of the monitoring box 69 is 120 min. The ratio of the air volume from the tail gas to the air volume from the high-temperature cracking chamber 2 for the secondary air fan 29 is 1:0.3. The air volume of the primary air fan 23 is 6000 m³/(ton·hour). The water level in the material collecting pit 79 is 60% of the depth of the material collecting pit 79. The water level in the slag storage tank 25 is 50% of the depth of the slag storage tank 25. The distance between adjacent hot air inlets 83 in each of the upper row, the middle row, and the lower row is 1.2 m. The distance between the upper row and the lower row is 1.5 m. The inclination angles of the hot air inlets 83 in the upper row, the middle row, and the lower row are 30° downward, 15° downward, and 20° upward, respectively. The angles between tangents of the first dust suppression plate 22, the second dust suppression plate 36, and the ash baffle plate 76 and the horizontal direction are 80°, 85°, and 65°, respectively. The biomass additive is graphite powder. The additive is a mixture of modified woody biochar, fiberglass reinforced plastic powder, calcium sulfate, diatomite, ceramic powder, and activated carbon, with a mixing ratio of 1:0.1:0.05:0.08:0.15:0.25. The modified woody biochar in the additive is a mixture of ferric chloride-modified biochar and NaOH-modified biochar with a mixing ratio of 1:0.8. The concentration of the ferric chloride modifier is 0.1 mol/L. The concentration of the NaOH modifier is 0.05 mol/L. The modification time is 72 h.

In Example 3, the pyrolysis chamber 1, the high-temperature cracking chamber 2, the material drying chamber 3, the biomass gas treatment chamber 9, and the metal carbonization chamber 10 are each provided with 8 temperature points and 4 pressure points. The steam boiler 4 is provided with 4 temperature points and 2 pressure points. The second connecting gas pipe 52 and the exhaust pipe 68 are each provided with 4 temperature points. The lower hot air pipe 39 is provided with 2 temperature points.

In Example 3, the organic solid waste in the pyrolysis chamber 1 is dried Chinese medicine residues. The metal-containing waste in the metal carbonization chamber 10 is fabric metal zippers. The material to be dried in the material drying chamber 3 is Chinese medicine residues. The temperature of the metal carbonization chamber 10 in a range of 350-600° C.

In Example 3, the water content of the dried Chinese medicine residues is in a range of 12.7%-18.5% and the calorific value of the dried Chinese medicine residues is in a range of 3200 kcal/kg-4500 kcal/kg. The water content of the fabric metal zippers is in a range of 10.2%-12.3%. The water content of the material to be dried in the material drying chamber 3 is in a range of 46.9%-53.3%, and the particle size of the material to be dried is in a range of 5-40 mm.

In Example 3, the operating load of the pyrolysis chamber 1 is 1.5 m³/h. The volume inside the high-temperature cracking chamber 2 is 15 m³. Volumes of other devices match the pyrolysis chamber 1 and the high-temperature cracking chamber 2. Experimental results show that the thermal energy conversion rate of the organic solid waste is as high as 90.3%-95.6%. The metal extraction rate is 95.1%-98.7%. The integrated device achieves a reduction in tail gas generation of 55.2%-63.6%. The tail gas treatment cost is reduced by 73.5%-80.6%. The carbonization efficiency is improved by 52.6%-58.3%.

The integrated device achieves drying of the Chinese medicine residues. The integrated device achieves recovery of metals from the fabric metal zippers. The integrated device achieves an operating load of 2.0 tons/hour for drying the Chinese medicine residues. The integrated device achieves an operating load of 1.5 tons/hour for metal recovery from the fabric metal zippers, thereby achieving near-zero emission of pollutants. Pollutant emission indicators monitored in the tail gas are shown in Table 3. Both NOx and HCl are below detection limits. Monitoring indicator values of the NOx and HCl are zero. Other indicators are significantly lower than national standard limits.

TABLE 3
emission indicators table of the tail gas in Example 3

| Pollutant | Dioxins | NOₓ | SO₂ | HCl | CO |
|---|---|---|---|---|---|
| item | (ng TEQ/m³) | (mg/m³) | (mg/m³) | (mg/m³) | (mg/m³) |
| Concentration | 0.007 ± 0.002 | 0.000 | 0.519 ± 0.072 | 0.000 | 3.125 ± 0.616 |
| Standard limit | 0.1 | 250 | 80 | 50 | 80 |

| | | | | | Sb, As, Pb, |
|---|---|---|---|---|---|
| | | | | Total | Cr, Co, Cu, |
| | | Hg and | Cd, Tl, and | volatile | Mn, Ni, and |
| | Particulate | related | related | organic | related |
| Pollutant | matter | compounds | compounds | compounds | compounds |
| item | (mg/m³) | (mg/m³) | (mg/m³) | (mg/m³) | (mg/m³) |
| Concentration | 0.759 ± 0.125 | (1.83 ± 0.32) × | (5.22 ± 0.76) × | 2.146 ± 0.526 | 0.026 ± 0.007 |
| | | 10⁻⁴ | 10⁻³ | | |
| Standard limit | 20 | 0.05 | 0.1 | 60 | 1.0 |

It should be noted that the standard limit for total volatile organic compounds is adopted from the “Emission Control Standard for Volatile Organic Compounds of Industrial Enterprises” (DB12/524-2020). Other indicators in the table are adopted from the “Standard for Pollution Control on the Municipal Solid Waste Incineration” (GB18485-2014).

### Example 4

This example takes the drying and utilization of the chicken manure and the recovery of aluminum from aluminum-containing mineral powder as an illustration.

In Example 4, the ash cleaning interval of the ash cleaning fan 32 is 8 h. The spray agent of the spray chamber 6 is a mixture of aluminum hydroxide, activated carbon, and ceramic powder, with a mixing ratio of 1:0.25:0.2 and a dosage of 1000 g/m³. The data acquisition interval of the monitoring box 69 is 80 min. The ratio of the air volume from the tail gas to the air volume from the high-temperature cracking chamber 2 for the secondary air fan 29 is 1:0.2. The air volume of the primary air fan 23 is 4000 m³/(ton·hour). The water level in the material collecting pit 79 is 50% of the depth of the material collecting pit 79. The water level in the slag storage tank 25 is 40% of the depth of the slag storage tank 25. The distance between adjacent hot air inlets 83 in each of the upper, the middle, and the lower rows is 0.8 m. The distance between the upper row and the lower row is 1.0 m. The inclination angles of the hot air inlets 83 in the upper row, the middle row, and the lower row are 20° downward, 10° downward, and 10° upward, respectively. The angles between tangents of the first dust suppression plate 22, the second dust suppression plate 36, and the ash baffle plate 76 and the horizontal direction are 60°, 75°, and 55°, respectively. The biomass additive at the combustion accelerator inlet 27 is charcoal powder. The additive is a mixture of modified woody biochar, fiberglass reinforced plastic powder, calcium sulfate, diatomite, ceramic powder, and activated carbon, with a mixing ratio of 1:0.05:0.03:0.06:0.12:0.15. The modified woody biochar in the additive is a mixture of ferric chloride-modified biochar and NaOH-modified biochar with a mixing ratio of 1:0.6. The concentration of the ferric chloride modifier is 0.05 mol/L. The concentration of the NaOH modifier is 0.03 mol/L. The modification time is 48 h.

In Example 4, the pyrolysis chamber 1, the high-temperature cracking chamber 2, the material drying chamber 3, the biomass gas treatment chamber 9, and the metal carbonization chamber 10 are each provided with 4 temperature points and 2 pressure points; the steam boiler 4 is provided with 2 temperature points and 2 pressure points; the second connecting gas pipe 52 and the exhaust pipe 68 are each provided with 2 temperature points; and the lower hot air pipe 39 is provided with 2 temperature points.

In Example 4, the organic solid waste in the pyrolysis chamber 1 is dried chicken manure. The metal-containing waste in the metal carbonization chamber 10 is aluminum-containing mineral powder. The material to be dried in the material drying chamber 3 is the chicken manure. When the metal carbonization chamber 10 recovers aluminum metal from minerals, the temperature is in a range of 600-950° C.

In Example 4, the water content of the dried chicken manure is in a range of 12.3%-19.6% and the calorific value of the dried chicken manure is in a range of 3000-3200 kcal/kg. The water content of the aluminum-containing mineral powder is in a range of 10.2%-12.7%. The water content of the chicken manure to be dried in the material drying chamber 3 is in a range of 49.3%-53.7%, and the particle size of the chicken manure to be dried is in a range of 5-40 mm.

In Example 4, an operating load of the pyrolysis chamber 1 is 2.0 m³/h. A volume inside the high-temperature cracking chamber 2 is 25 m³. Volumes of other devices match the pyrolysis chamber 1 and the high-temperature cracking chamber 2. Experimental results show that a thermal energy conversion rate of the organic solid waste is as high as 92.7%-96.5%. A metal extraction rate from the mineral powder is 81.7%-85.3%. The integrated device achieves a reduction in tail gas generation amount by 60.3%-75.7%. The integrated device achieves a reduction in tail gas treatment cost by 81.6%-85.3%. The integrated device achieves an improvement in carbonization efficiency by 53.7%-59.6%.

The integrated device achieves drying of chicken manure. The integrated device achieves recovery of aluminum metal from aluminum-containing mineral powder. The integrated device achieves an operating load of 6.0 tons/hour for drying chicken manure. The integrated device achieves an operating load of 1.5 tons/hour for recovering aluminum metal from aluminum-containing mineral powder, thereby achieving near-zero emission of pollutants. When thermal energy is insufficient, the thermal energy is supplemented by heat released from pyrolysis of the dried chicken manure. Pollutant emission indicators monitored in tail gas are shown in Table 4. NOx, SO₂, and HCl are all below detection limits. Monitored indicator values are zero. Other indicators are significantly lower than national standard limits.

TABLE 4
emission indicators table of the tail gas in Example 4

| Pollutant | Dioxins | NOₓ | SO₂ | HCl | CO |
|---|---|---|---|---|---|
| item | (ng TEQ/m³) | (mg/m³) | (mg/m³) | (mg/m³) | (mg/m³) |
| Concentration | 0.006 ± 0.001 | 0.000 | 0.000 | 0.000 | 1.229 ± 0.133 |
| Standard Limit | 0.1 | 250 | 80 | 50 | 80 |

| | | | | | Sb, As, Pb, |
|---|---|---|---|---|---|
| | | | | Total | Cr, Co, Cu, |
| | | Hg and | Cd, Tl, and | volatile | Mn, Ni, and |
| | Particulate | related | related | organic | related |
| Pollutant | matter | compounds | compounds | compounds | compounds |
| item | (mg/m³) | (mg/m³) | (mg/m³) | (mg/m³) | (mg/m³) |
| Concentration | 2.156 ± 0.227 | (1.25 ± 0.31) × | (6.15 ± 0.69) × | 1.357 ± 0.351 | 0.055 ± 0.016 |
| | | 10⁻⁴ | 10⁻³ | | |
| Standard Limit | 20 | 0.05 | 0.1 | 60 | 1.0 |

It should be noted that the standard limit for total volatile organic compounds is adopted from the “Emission Control Standard for Volatile Organic Compounds of Industrial Enterprises” (DB12/524-2020). Other indicators in the table are adopted from the “Standard for Pollution Control on the Municipal Solid Waste Incineration” (GB18485-2014).

The integrated device for drying organic solid waste and extracting metals of the present disclosure achieves a thermal energy conversion rate of organic solid waste greater than 90%, a metal extraction rate from organic solid waste exceeding 90%, a metal extraction rate from mineral powder exceeding 70%, a reduction in tail gas generation by more than 50%, a reduction in tail gas treatment cost by more than 70%, and an increase in carbonization efficiency by more than 50%. The integrated device for drying organic solid waste and extracting metals has high production efficiency, large product output, and high degree of industrialization. The integrated device for drying organic solid waste and extracting metals fully utilizes the thermal energy generated by the waste material itself, significantly reduces energy consumption, consumes no other energy except a small amount of electrical energy, and has low operating costs.

The embodiments of the present disclosure disclosed above are merely for helping to illustrate the present disclosure. The embodiments do not describe all details exhaustively, nor do they limit the present disclosure to the described specific implementations. Many modifications and variations may be made according to the content of the present disclosure. These embodiments are selected and specifically described in the present disclosure to better explain the principles and practical applications of the present disclosure, thereby enabling those skilled in the art to well understand and utilize the present disclosure.

What is claimed is:

1. An integrated device for drying organic solid waste and extracting metals, comprising:
a pyrolysis chamber (1), a high-temperature cracking chamber (2), a material drying chamber (3), a steam boiler (4), a cyclonic dust removal chamber (5), a spray chamber (6), an electrostatic dust removal chamber (7), a water bath purification chamber (8), a biomass gas treatment chamber (9), and a metal carbonization chamber (10), wherein
the pyrolysis chamber (1) is connected to the high-temperature cracking chamber (2) through an air passage port (26), a first biomass air inlet (16) is disposed on the pyrolysis chamber (1), a second biomass air inlet (37) is disposed on the high-temperature cracking chamber (2), and the high-temperature cracking chamber (2) is connected to the material drying chamber (3) through a lower hot air pipe (39) and an upper hot air pipe (40);
an air-drying cylinder (41) is disposed in the material drying chamber (3), the upper hot air pipe (40) is in communication with an interior of the air-drying cylinder (41), the lower hot air pipe (39) is in communication with a space outside the air-drying cylinder (41), the space outside the air-drying cylinder (41) is in communication with the steam boiler (4) through a first connecting gas pipe (48), and the interior of the air-drying cylinder (41) is in communication with a discharge pipe (47);
a hot air outlet (49) is disposed on the first connecting gas pipe (48), a first gas outlet (45) is disposed on the discharge pipe (47), a hot water inlet (50) is disposed on the steam boiler (4), and the steam boiler (4) is connected to the cyclonic dust removal chamber (5) through a second connecting gas pipe (52);
a cyclonic exhaust pipe (54) is disposed in the cyclonic dust removal chamber (5), the cyclonic exhaust pipe (54) is connected to the spray chamber (6) through a third connecting gas pipe (56), an induced draft fan (55) is disposed on the third connecting gas pipe (56), the spray chamber (6) is connected to the electrostatic dust removal chamber (7) through a fourth connecting gas pipe (60), the electrostatic dust removal chamber (7) is connected to the water bath purification chamber (8) through a fifth connecting gas pipe (61), the water bath purification chamber (8) is connected to an exhaust pipe (68), and the exhaust pipe (68) is connected to the high-temperature cracking chamber (2) through a tail gas recovery pipe (70);
a plurality of condenser tubes (87) are disposed in the biomass gas treatment chamber (9) in a transverse arrangement, one end of each condenser tube (87) is a gas inlet (88), and the other end of each condenser tube (87) is a gas passage port (92), the gas passage port (92) is connected to a drying chamber (94), and a second gas outlet (95) is disposed on the drying chamber (94);
a water inlet (89) and a water outlet (93) are disposed on the biomass gas treatment chamber (9), the second gas outlet (95) is connected to the first biomass air inlet (16) through a gas return pipe (86), the gas inlet (88) is connected to the first gas outlet (45) through a first hot air inlet pipe (84), and the water outlet (93) is connected to the hot water inlet (50) through a first connecting water pipe (98); and
a pyrolysis gas outlet (81) and a plurality of hot air inlets (83) are disposed on the metal carbonization chamber (10), the pyrolysis gas outlet (81) is connected to the second biomass air inlet (37) through a gas outlet pipe (85), and the plurality of hot air inlets (83) are connected to the hot air outlet (49) through a second hot air inlet pipe (107).

2. The integrated device according to claim 1, wherein:
a pyrolysis chamber feed inlet (116) is disposed on a side of the pyrolysis chamber (1), a first ash discharge port (21) is disposed on a bottom surface of the pyrolysis chamber (1), and the first ash discharge port (21) is gravity-sensing openable and closable;
a grate (20) is disposed in the pyrolysis chamber (1), the grate (20) is connected to a third speed reducer (101), one end of the grate (20) is disposed at the pyrolysis chamber feed inlet (116), and the other end of the grate (20) is proximate to the first ash discharge port (21);
a slag storage tank (25) is disposed below the first ash discharge port (21), water is contained in the slag storage tank (25) with a water level at 30%-50% of a depth of the slag storage tank (25), and the slag storage tank (25) is connected to a slag remover (96); and
a first dust suppression plate (22) is disposed in the pyrolysis chamber (1), the first dust suppression plate (22) is located at the air passage port (26), the first dust suppression plate (22) has an arched structure, and a tangent of the arched structure forms an angle of 55°-80° with a horizontal direction.

3. The integrated device according to claim 1, wherein:
a second ash discharge port (31) is disposed on a bottom surface of the high-temperature cracking chamber (2), a lower side of the second ash discharge port (31) is connected to an ash discharge pipe (33) through an ash cleaning fan (32), an outlet end of the ash discharge pipe (33) is disposed in an ash storage box (35), and the outlet end of the ash discharge pipe (33) is connected to an ash cover (34) via a spring; and
a second dust suppression plate (36) is disposed in the high-temperature cracking chamber (2), the second dust suppression plate (36) is located below the lower hot air pipe (39), the second dust suppression plate (36) has an arched structure, and a tangent of the arched structure forms an angle of 65°-85° with a horizontal direction.

4. The integrated device according to claim 1, wherein:
an additive inlet (104) is disposed on a side of the high-temperature cracking chamber (2), and a combustion accelerator inlet (27), a self-circulation outlet (99), and a self-circulation inlet (100) are disposed on a top surface of the high-temperature cracking chamber (2);
the self-circulation inlet (100) is disposed on a side proximate to the pyrolysis chamber (1), the self-circulation outlet (99) is disposed on a side proximate to the material drying chamber (3), the tail gas recovery pipe (70) is connected to the self-circulation inlet (100) through an air intake pipe (28), and the tail gas recovery pipe (70) is connected to the self-circulation outlet (99) through an air exhaust pipe (108); and
a secondary air fan (29) is disposed on the air intake pipe (28), and an airflow control valve (30) is disposed on each of the tail gas recovery pipe (70) and the air exhaust pipe (108).

5. The integrated device according to claim 1, wherein:
a plurality of blades (42) are disposed inside the air-drying cylinder (41), a dust removal outlet (43) is disposed at a lower portion of the material drying chamber (3), the dust removal outlet (43) is connected to a dust storage tank (44), and a discharge valve (46) is disposed on the discharge pipe (47).

6. The integrated device according to claim 1, wherein:
a steam outlet (51) is disposed on a top of the steam boiler (4), and an airflow control valve (30) is disposed on the steam outlet (51).

7. The integrated device according to claim 1, wherein:
a dust settling hole (102) is disposed at a bottom of the cyclonic dust removal chamber (5), the dust settling hole (102) is located in an ash storage bucket (53), a dust baffle plate (103) is disposed above the dust settling hole (102), and the cyclonic exhaust pipe (54) has a structure that is larger at an upper portion and smaller at a lower portion.

8. The integrated device according to claim 1, wherein:
a water storage chamber (58) is disposed at an upper portion of the spray chamber (6), a plurality of spray nozzles (57) are disposed below the water storage chamber (58), and a lower portion of the spray chamber (6) is connected to a slurry storage tank (59).

9. The integrated device according to claim 1, wherein:
two purification assemblies are disposed in the water bath purification chamber (8), and each of the two purification assemblies comprises a plurality of filter balancing plates (67) arranged at intervals; and
a first slag discharge pipe (62) and a second slag discharge pipe (63) are respectively disposed for the two purification assemblies, a slag discharge hopper (64) is disposed below each of the two purification assemblies, a slag discharge port (65) is disposed below the slag discharge hopper (64), the slag discharge port (65) is located in a collection bucket (66), and the slag discharge port (65) is closed during operation and opened during slag discharge.

10. The integrated device according to claim 1, wherein:
the condenser tubes (87) are connected to a water tank (91) through a water valve (90); gas inlets (88) and gas passage ports (92) of the plurality of condenser tubes (87) are respectively located at an upper portion and a lower portion of the biomass gas treatment chamber (9); the second gas outlet (95) is located at an upper portion of the drying chamber (94); the water inlet (89) and the water outlet (93) are respectively located at the lower portion and a top of the biomass gas treatment chamber (9); and the water inlet (89) is connected to a first water storage tank (112) through a third connecting water pipe (113).

11. The integrated device according to claim 1, wherein:
a metal carbonization chamber feed inlet (117) is disposed on a side of the metal carbonization chamber (10), a material collecting pit (79) is disposed on a bottom surface of the metal carbonization chamber (10), the material collecting pit (79) has a tubular cross-section, a discharge hopper (80) is disposed on an upper side of the material collecting pit (79), and the discharge hopper (80) is gravity-sensing openable and closable;
water is contained in the material collecting pit (79) with a water level at 40%-60% of a depth of the material collecting pit (79), the material collecting pit (79) is connected to a slag remover (96), a cooling tube (109) is disposed on an inner side of the material collecting pit (79), the cooling tube (109) is connected to the steam boiler (4) through a second connecting water pipe (110), a circulation water pump (111) is disposed on the second connecting water pipe (110), and the cooling tube (109) is connected to a second water storage tank (114) through a fourth connecting water pipe (115); and
an upper mesh belt conveyor (77) and a lower mesh belt conveyor (78) are disposed in the metal carbonization chamber (10), the upper mesh belt conveyor (77) is disposed above the lower mesh belt conveyor (78), one end of the upper mesh belt conveyor (77) is disposed at the metal carbonization chamber feed inlet (117), one end of the lower mesh belt conveyor (78) is proximate to the material collecting pit (79), the upper mesh belt conveyor (77) is connected to a first speed reducer (75), and the lower mesh belt conveyor (78) is connected to a second speed reducer (82).

12. The integrated device according to claim 1, wherein:
the plurality of hot air inlets (83) are arranged in three rows, including an upper row, a middle row, and a lower row, along a vertical height direction of the metal carbonization chamber (10); a distance between adjacent hot air inlets (83) in each row is in a range of 0.4-1.2 m, and a distance between the upper row and the lower row is in a range of 0.5-1.5 m; and
hot air inlets (83) located in the upper row have a downward inclination angle of 8°−30°, hot air inlets (83) located in the middle row have a downward inclination angle of 1°−15°, and hot air inlets (83) located in the lower row have an upward inclination angle of 3°−20°.

13. The integrated device according to claim 2, wherein:
the pyrolysis chamber (1) is connected to a first feeding system (11), and the first feeding system (11) comprises a first storage bin (13), a first feeder (14), and a material pushing system (17);
one end of the first feeder (14) is disposed inside the first storage bin (13), the other end of the first feeder (14) is disposed above the material pushing system (17), the material pushing system (17) is located at the pyrolysis chamber feed inlet (116), the material pushing system (17) is connected to a motor (18), and a positioning plate (15) is disposed at the pyrolysis chamber feed inlet (116); and
a cover plate (106) is disposed above the positioning plate (15), the cover plate (106) is connected to the pyrolysis chamber (1), the first biomass air inlet (16) is disposed on the cover plate (106), a front end of the material pushing system (17) is a push plate (105), and the push plate (105) is sealed with the cover plate (106) after being pushed out.

14. The integrated device according to claim 11, wherein:
the metal carbonization chamber (10) is connected to a second feeding system (12), the second feeding system (12) comprises a second storage bin (71), a second feeder (72), and a screw feeder (73), one end of the second feeder (72) is disposed inside the second storage bin (71), the other end of the second feeder (72) is disposed above the screw feeder (73), and the screw feeder (73) is disposed at the metal carbonization chamber feed inlet (117); and
a dust shield plate (74) is disposed above the screw feeder (73), the dust shield plate (74) is connected to the metal carbonization chamber (10), an ash baffle plate (76) is disposed inside the metal carbonization chamber (10), the ash baffle plate (76) is disposed at the metal carbonization chamber feed inlet (117), the ash baffle plate (76) has an arched structure, and a tangent of the arched structure forms an angle of 35°-65° with a horizontal direction.

15. The integrated device according to claim 1, wherein:
a primary air duct (24) is disposed at a bottom of the pyrolysis chamber (1), a primary air fan (23) is connected to the primary air duct (24), and an air volume of the primary air fan (23) is 2000-6000 m³/(ton·hour) for organic solid waste; and
a top surface of the high-temperature cracking chamber (2) is provided with an oxygen inlet pipe (19), wherein a gas having an oxygen content exceeding 70% is introduced into the oxygen inlet pipe (19).

16. The integrated device according to claim 1, wherein:
each of the pyrolysis chamber (1), the high-temperature cracking chamber (2), the material drying chamber (3), the biomass gas treatment chamber (9), and the metal carbonization chamber (10) is provided with 4-8 temperature monitoring points (38) and 2-4 pressure monitoring points (97); and
the steam boiler (4) is provided with 2-4 temperature monitoring points (38) and 2 pressure monitoring points (97), the second connecting gas pipe (52) is provided with 2-4 temperature monitoring points (38), the exhaust pipe (68) is provided with 2-4 temperature monitoring points (38), and the lower hot air pipe (39) is provided with 2 temperature monitoring points (38).

17. The integrated device according to claim 1, wherein:
the exhaust pipe (68) is provided with a monitoring box (69), wherein the monitoring box (69) is provided with probes for a variety of monitoring gases.

18. The integrated device according to claim 1, wherein:
organic solid waste is added into the pyrolysis chamber (1), wherein the organic solid waste has a water content below 20% and a calorific value higher than 3000 kcal/kg,
metal-containing waste is added into the metal carbonization chamber (10), wherein the metal-containing waste has a water content below 15%, and
material to be dried in the material drying chamber (3) has a water content below 55% and a particle size of 5-40 mm.

19. A method implemented on an integrated device for drying organic solid waste and extracting metals, the integrated device comprising:
a pyrolysis chamber (1), a high-temperature cracking chamber (2), a material drying chamber (3), a steam boiler (4), a cyclonic dust removal chamber (5), a spray chamber (6), an electrostatic dust removal chamber (7), a water bath purification chamber (8), a biomass gas treatment chamber (9), and a metal carbonization chamber (10), wherein
the pyrolysis chamber (1) is connected to the high-temperature cracking chamber (2) through an air passage port (26), a first biomass air inlet (16) is disposed on the pyrolysis chamber (1), a second biomass air inlet (37) is disposed on the high-temperature cracking chamber (2), and the high-temperature cracking chamber (2) is connected to the material drying chamber (3) through a lower hot air pipe (39) and an upper hot air pipe (40);
an air-drying cylinder (41) is disposed in the material drying chamber (3), the upper hot air pipe (40) is in communication with an interior of the air-drying cylinder (41), the lower hot air pipe (39) is in communication with a space outside the air-drying cylinder (41), the space outside the air-drying cylinder (41) is in communication with the steam boiler (4) through a first connecting gas pipe (48), and the interior of the air-drying cylinder (41) is in communication with a discharge pipe (47);
a hot air outlet (49) is disposed on the first connecting gas pipe (48), a first gas outlet (45) is disposed on the discharge pipe (47), a hot water inlet (50) is disposed on the steam boiler (4), and the steam boiler (4) is connected to the cyclonic dust removal chamber (5) through a second connecting gas pipe (52);
a cyclonic exhaust pipe (54) is disposed in the cyclonic dust removal chamber (5), the cyclonic exhaust pipe (54) is connected to the spray chamber (6) through a third connecting gas pipe (56) an induced draft fan (55) is disposed on the third connecting gas pipe (56), the spray chamber (6) is connected to the electrostatic dust removal chamber (7) through a fourth connecting gas pipe (60), the electrostatic dust removal chamber (7) is connected to the water bath purification chamber (8) through a fifth connecting gas pipe (61), the water bath purification chamber (8) is connected to an exhaust pipe (68), and the exhaust pipe (68) is connected to the high-temperature cracking chamber (2) through a tail gas recovery pipe (70);
a plurality of condenser tubes (87) are disposed in the biomass gas treatment chamber (9) in a transverse arrangement, one end of each condenser tube (87) is a gas inlet (88), and the other end is a gas passage port (92), the gas passage port (92) is connected to a drying chamber (94), and a second gas outlet (95) is disposed on the drying chamber (94);
a water inlet (89) and a water outlet (93) are disposed on the biomass gas treatment chamber (9), the second gas outlet (95) is connected to the first biomass air inlet (16) through a gas return pipe (86), the gas inlet (88) is connected to the first gas outlet (45) through a first hot air inlet pipe (84), and the water outlet (93) is connected to the hot water inlet (50) through a first connecting water pipe (98); and
a pyrolysis gas outlet (81) and a plurality of hot air inlets (83) are disposed on the metal carbonization chamber (10), the pyrolysis gas outlet (81) is connected to the second biomass air inlet (37) through a gas outlet pipe (85), and the plurality of hot air inlets (83) are connected to the hot air outlet (49) through a second hot air inlet pipe (107);
wherein the method comprises:
adding the organic solid waste into the pyrolysis chamber (1) for pyrolysis, a generated pyrolysis gas entering the high-temperature cracking chamber (2) through the air passage port (26) for cracking treatment, hot air generated by cracking entering into the material drying chamber (3) through the lower hot air pipe (39) to heat an outer side of the air-drying cylinder (41), and hot air generated by cracking through the upper hot air pipe (40) heating and drying a material to be dried inside the air-drying cylinder (41);
a portion of the hot air on the outer side of the air-drying cylinder (41) entering the metal carbonization chamber (10) through the hot air outlet (49), the other portion of the hot air on the outer side of the air-drying cylinder (41) entering the steam boiler (4) through the first connecting gas pipe (48), the metal carbonization chamber (10) carbonizing and recovering added metal-containing waste, a generated gas entering the high-temperature cracking chamber (2) sequentially through the pyrolysis gas outlet (81), the gas outlet pipe (85), and the second biomass air inlet (37);
the hot air in the air-drying cylinder (41) entering the biomass gas treatment chamber (9) sequentially through the first gas outlet (45), the first hot air inlet pipe (84), and the gas inlet (88), after the hot air is dehydrated in the biomass gas treatment chamber (9), the hot air entering the pyrolysis chamber (1) sequentially through the second gas outlet (95), the gas return pipe (86), and the first biomass air inlet (16) to be pyrolyzed;
the hot air entering the steam boiler (4) being heat-absorbed and then, under action of the induced draft fan (55), being treated sequentially through the cyclonic dust removal chamber (5), the spray chamber (6), the electrostatic dust removal chamber (7), and the water bath purification chamber (8); and
a portion of gas purified by the water bath purification chamber (8) entering the high-temperature cracking chamber (2) through the tail gas recovery pipe (70), and the other portion being discharged externally through the exhaust pipe (68).

20. The method according to claim 19, wherein:
a temperature of the pyrolysis chamber (1) is in a range of 350-600° C.; a temperature of the high-temperature cracking chamber (2) is in a range of 850-1000° C.; when the metal carbonization chamber (10) recovers metal from the organic solid waste, a temperature of the metal carbonization chamber (10) is in a range of 350-600° C.; and when the metal carbonization chamber (10) recovers metal from a mineral, a temperature of the metal carbonization chamber (10) is in a range of 600-950° C.
